(19) United States
(12) Patent Application Publication
(10) Pub. No.: US 2023/0219039 A1
(43) Pub. Date: Jul. 13, 2023

(54) EXHAUST GAS TREATMENT SYSTEM COMPRISING A MULTIFUNCTIONAL CATALYST

(71) Applicant: BASF CORPORATION, Florham Park, NJ (US)

(72) Inventors: Robert DORNER, Hannover (DE); Ansgar WILLE, Hannover (DE); Tobias PAUL, Hannover (DE)

(21) Appl. No.: 17/999,216

(22) PCT Filed: Jun. 11, 2021
(86) PCT No.: PCT/EP2021/065750

§ 371 Date: Nov. 18, 2022

(30) Foreign Application Priority Data
Jun. 12, 2020 (EP) 20179647.1

(51) Int. Cl. B01D 53/94; B01J 29/76; B01J 23/44; B01J 23/42; B01J 21/06; B01J 21/04; B01J 35/00; B01J 37/02; B01J 37/08; F01N 3/10; F01N 3/20; F01N 3/28

(52) U.S. Cl. CPC B01D 53/9477; B01D 53/944; B01D 53/9418; B01D 53/9436; B01D 53/9468; B01J 21/04; B01J 21/063; B01J 21/066; B01J 23/42; B01J 23/44; B01J 29/763; B01J 35/0006; B01J 35/0066; B01J 37/088; B01J 37/0228; B01J 37/0236; B01J 37/0244; F01N 3/103; F01N 3/2066; F01N 3/2828; B01D 2251/208; B01D 2251/2062; B01D 2255/50; B01D 2255/1021; B01D 2255/1023; B01D 2255/2092; B01D 2255/9032; B01D 2255/20707; B01D 2255/20715; B01D 2255/20738; B01D 2255/20761; F01N 2370/04; F01N 2610/03

(57) ABSTRACT

The present invention relates to an exhaust gas treatment system for treating exhaust gas from a lean burn combustion engine, wherein said exhaust gas comprises hydrocarbons and NOx, the exhaust gas treatment system comprising: (i) a means for injecting hydrocarbons into an exhaust gas stream; (ii) a diesel oxidation catalyst (DOC) comprising a substrate and a catalyst coating provided on the substrate, wherein the catalyst coating comprises one or more platinum group metals, wherein the one or more platinum group metals comprise platinum; (iii) a means for injecting a nitrogenous reducing agent into an exhaust gas stream; and (iv) a multifunctional catalyst (MFC) comprising an oxidation catalyst, and a selective catalytic reduction (SCR) catalyst for the selective catalytic reduction of NOx, wherein the MFC comprises a substrate and a catalyst coating provided on the substrate, wherein the catalyst coating comprises the oxidation catalyst and the SCR catalyst, wherein the oxidation catalyst comprises one or more platinum group metals, wherein the one or more platinum group metals comprise palladium and/or platinum, and wherein the SCR catalyst comprises a zeolitic material loaded with copper and/or iron; wherein the means for injecting hydrocarbons, the DOC, the means for injecting a nitrogenous reducing agent, and the MFC are located in sequential order in a conduit for exhaust gas, wherein the means for injecting hydrocarbons into an exhaust gas stream is located upstream of the DOC, wherein the DOC is located upstream of the MFC, and wherein the means for injecting a nitrogenous reducing agent into the exhaust gas stream is located between the DOC and the MFC. Furthermore, the present invention relates to a method for the treatment of exhaust gas using the exhaust gas treatment system according to the present invention, and to a method for the preparation of an exhaust gas treatment system according to the present invention.

The present invention relates generally to the field of selective catalytic reduction (SCR) catalysis, in particular in automotive applications. More specifically, the present invention relates to a system for treating exhaust gas from a lean burn combustion engine comprising a diesel oxidation catalyst, a means for injection of a hydrocarbon and/or a means for injection of a nitrogen reductant and a multifunctional catalyst comprising an SCR catalyst, and a further oxidation catalyst. Furthermore, the present invention relates to a method for the treatment of exhaust gas using the exhaust gas treatment system according to the present invention, and to a method for the preparation of an exhaust gas treatment system according to the present invention.

Harmful components of nitrogen oxides (NOₓ) lead to atmospheric pollution. NOₓ is contained in exhaust gases, such as from internal combustion engines (e.g., in automobiles and trucks), from combustion installations (e.g., power stations heated by natural gas, oil, or coal), and from nitric acid production plants. Various treatment methods are used to lower NOₓ in exhaust gases and thus decrease atmospheric pollution. One type of treatment involves catalytic reduction of nitrogen oxides. There are two processes: (1) a nonselective reduction process wherein carbon monoxide, hydrogen, or a lower hydrocarbon is used as a reducing agent; and (2) a selective reduction process wherein ammonia or an ammonia precursor is used as a reducing agent. In the selective reduction process, a high degree of nitrogen oxide removal can be achieved with a small amount of reducing agent.

The selective reduction process is referred to as a SCR (Selective Catalytic Reduction) process. The SCR process uses catalytic reduction of nitrogen oxides with a reductant (e.g. ammonia or ammonia precursor) in the presence of atmospheric oxygen, resulting in the formation predominantly of nitrogen and steam:

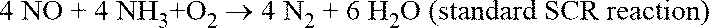

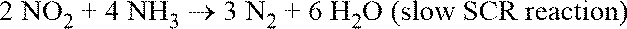

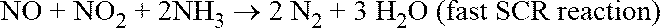

This process is considered one of the most viable techniques for the removal of nitrogen oxides from engine exhaust gas. In a typical exhaust gas, the nitrogen oxides are mainly composed of NO (> 90 %), which is converted by the SCR catalyst into nitrogen and water in the presence of ammonia (standard SCR reaction). NH₃ is one of the most effective reductants although urea can also be used as an ammonia precursor. Generally, catalysts employed in the SCR process should have good catalytic activity over a wide range of temperature, for example, from below 200° C. to 600° C. or higher. Higher temperatures are commonly encountered during the regeneration of soot filters and during the regeneration of SCR catalysts. For soot filters, regeneration refers to the periodic need to remove accumulated soot within the filter. Temperatures greater than 500° C. are needed for typically 20 minutes or more to effectively burn soot. Such temperatures are not encountered during normal engine operation.

Over time, minor components of the exhaust gas either collect or interact with the SCR catalyst, reducing the effectiveness of the catalyst over time. To maintain high efficiency, it is necessary to periodically remove these contaminants. For example, sulfur oxides can react with ammonia to form ammonium sulfates, which block active sites on the catalyst, leading to activity loss. Also, prolonged operation of SCR catalysts at temperature below about 300° C. can lead to the accumulation of hydrocarbons on the catalyst surface. Eventually these hydrocarbons also block active sites, leading to a loss in catalytic activity.

In view of the contamination of the SCR catalyst, higher temperatures are periodically necessary to remove these and other contaminants and to maintain high catalytic efficiency. Achieving temperatures to regenerate SCR catalysts requires hydrocarbon addition and oxidation thereof over an oxidation catalyst upstream of the SCR catalyst for raising the exhaust temperature to a point where desulfation of the SCR catalyst can take place. When doing so, hydrocarbon-slip out of the oxidation catalyst and onto the selective catalytic reduction catalyst can lead to coking and thus to deactivation of the SCR component. Furthermore, generating an exotherm over the oxidation catalyst in this fashion may also be used to heat up the SCR catalyst when its activity for the abatement of NOx is insufficient, wherein said step may equally lead to hydrocarbon-slip and subsequent coking thereof on the SCR component.

WO 2018/224651 A2 relates to an exhaust gas treatment system, wherein said document discloses amongst others an exhaust gas treatment system comprising a 1st catalyst which is a DOC comprising palladium followed by an SCR catalyst downstream thereof, wherein said SCR catalyst comprises a zeolitic material comprising copper and/or iron. According to preferred embodiments of WO 2018/224651 A2 , the DOC is free of platinum and the SCR catalyst located downstream thereof comprises a platinum group metal which is preferably palladium. Said document further teaches that the HC slip exiting the DOC may be treated by the SCR catalyst located downstream thereof, wherein SCR catalysts devoid of palladium perform considerably better than SCR catalysts containing palladium with regard to the abatement of the hydrocarbons.

WO 2019/159151 A1, on the other hand, relates to an exhaust gas treatment system comprising a close-coupled SCR catalyst and a DOC located downstream thereof.

WO 2014/151677 A1 discloses a zoned DOC and its use in a system comprising an SCR located downstream of the DOC.

US 2011/078997 A1 discloses SCR loaded filter coated with the Pd alumina slurry.

WO 2016/160953 A1 discloses a catalyzed particulate filter that comprises two coats of SCR catalysts followed by a third coating of platinum group metal.

In view of the current technology, there remains the need for exhaust gas treatment systems which may alleviate the disadvantages of the prior art. In particular, there is the need for an exhaust gas treatment system which may effectively avoid the coking of the SCR catalyst due to hydrocarbon slip from an oxidation catalyst located upstream thereof, yet which still displays a high efficiency for the selective catalytic reduction of NOx which may be maintained over time.

### DETAILED DESCRIPTION

It was therefore an object of the present invention to provide an improved exhaust gas treatment system, in particular with regard to the coking resistance of the SCR catalyst. Thus, it has surprisingly been found that both hydrocarbon slip from an SCR catalyst as well as the coking thereof due to hydrocarbon slip from an oxidation catalyst located upstream thereof may be considerably reduced by including a platinum group metal, and in particular palladium in the SCR catalyst for affording a multifunctional catalyst (MFC). In particular, it has surprisingly been found that said unexpected technical effect is particularly pronounced in instances wherein the oxidation catalyst is located in a close-coupled position relative to the combustion engine, as a result of which it is prone to greater hydrocarbon slippage due to its reduced volume in view of size constraints at that position in the exhaust system.

Therefore, the present invention relates to an exhaust gas treatment system for treating exhaust gas from a lean burn combustion engine, wherein said exhaust gas comprises hydrocarbons and NOx, the exhaust gas treatment system comprising:
(i) a means for injecting hydrocarbons into an exhaust gas stream;
(ii) a diesel oxidation catalyst (DOC) comprising a substrate and a catalyst coating provided on the substrate, wherein the catalyst coating comprises one or more platinum group metals, wherein the one or more platinum group metals comprise, preferably consist of, platinum, preferably platinum and palladium;
(iii) a means for injecting a nitrogenous reducing agent into an exhaust gas stream; and
(iv) a multifunctional catalyst (MFC) comprising, preferably consisting of, an oxidation catalyst, and a selective catalytic reduction (SCR) catalyst for the selective catalytic reduction of NOx, wherein the MFC comprises a substrate and a catalyst coating provided on the substrate, wherein the catalyst coating comprises the oxidation catalyst and the SCR catalyst, wherein the oxidation catalyst comprises one or more platinum group metals, wherein the one or more platinum group metals comprise, preferably consist of, palladium and/or platinum, preferably palladium, and wherein the SCR catalyst comprises a zeolitic material loaded with copper and/or iron, preferably with copper;
wherein the means for injecting hydrocarbons, the DOC, the means for injecting a nitrogenous reducing agent, and the MFC are located in sequential order in a conduit for exhaust gas, wherein the means for injecting hydrocarbons into an exhaust gas stream is located upstream of the DOC, wherein the DOC is located upstream of the MFC, and wherein the means for injecting a nitrogenous reducing agent into the exhaust gas stream is located between the DOC and the MFC.

It is preferred that no further component is located in the exhaust gas treatment system between the means for injecting hydrocarbons according to (i) and the DOC according to (ii), wherein preferably no further component is located in the exhaust gas treatment system between the means for injecting the hydrocarbons according to (i) and the DOC according to (ii) and between the DOC according to (ii) and the means for injecting a nitrogenous reducing agent according to (iii) and between the means for injecting a nitrogenous reducing agent according to (iii) and the MFC according to (iv).

It is preferred that the exhaust gas treatment system further comprises a lean burn engine located upstream of the DOC according to (ii).

It is preferred that the DOC according to (ii) is close-coupled to the lean burn engine, wherein preferably the lean burn engine is a diesel engine.

It is preferred that the lean burn engine acts as a means for injecting hydrocarbons into an exhaust gas stream according to (i) by producing an exhaust gas stream comprising controlled amounts of hydrocarbons, preferably by secondary fuel injection.

It is preferred that a means for injecting hydrocarbons into an exhaust gas stream according to (i) is located between the lean burn engine and the DOC according to (ii).

It is preferred that no further component is located in the exhaust gas treatment system between the lean burn engine and the means for injecting hydrocarbons according to (i), wherein preferably no further component is located in the exhaust gas treatment system between the lean burn engine and the means for injecting hydrocarbons according to (i) and between the means for injecting hydrocarbons according to (i) and the DOC according to (ii) and between the DOC according to (ii) and the means for injecting a nitrogenous reducing agent according to (iii) and between the means for injecting a nitrogenous reducing agent according to (iii) and the MFC according to (iv).

It is preferred that no further component is located in the exhaust gas treatment system between the lean burn engine and the DOC according to (ii), wherein preferably no further component is located in the exhaust gas treatment system between the lean burn engine and the DOC according to (ii) and between the DOC according to (ii) and the means for injecting a nitrogenous reducing agent according to (iii) and between the means for injecting a nitrogenous reducing agent according to (iii) and the MFC according to (iv).

It is preferred that according to (ii) the substrate of the DOC comprises, preferably consists of, a ceramic substance, wherein the ceramic substance preferably comprises, more preferably consists of, one or more of an alumina, a silica, a silicate, an aluminosilicate, preferably a cordierite or a mullite, an aluminotitanate, a silicon carbide, a zirconia, a magnesia, preferably a spinel, and a titania, more preferably one or more of a silicon carbide and a cordierite, and more preferably a cordierite.

It is preferred that according to (ii) the substrate of the DOC comprises, preferably consists of, a metallic substance, wherein the metallic substance preferably comprises, more preferably consists of, oxygen and one or more of iron, chromium, and aluminum.

It is preferred that according to (ii) the substrate of the DOC is a monolith, preferably a honeycomb monolith, more preferably a flow-through honeycomb monolith.

It is preferred that according to (ii) the one or more platinum group metals present in the DOC are supported on one or more refractory metal oxides selected from the group consisting of, pseudoboehmite, alumina, y-alumina, lanthana, lanthana stabilized alumina, silica stabilized alumina, zirconia, titania, silica stabilized titania, ceria, ceria-zirconia, aluminosilicate, silica, and rare-earth metal sesquioxide, including mixtures thereof, preferably from the group consisting of pseudoboehmite, alumina, y-alumina, titania, silica stabilized titania and silica stabilized alumina, including mixtures thereof, wherein more preferably the one or more platinum group metals present in the DOC are supported on pseudoboehmite and/or silica stabilized alumina, more preferably on an equal weight mixture of pseudoboehmite and 2 to 6 wt.-% silica stabilized alumina.

It is preferred that according to (ii) the DV90 value of the particle size distribution of the one or more refractory metal oxide supports is in the range of 0.1 to 25 microns, preferably in the range of 1 to 20 microns, more preferably in the range of 2 to 18 microns, more preferably in the range of 3 to 17 microns, more preferably in the range of 4 to 16 microns, more preferably in the range of 5 to 15 microns, more preferably in the range of 7 to 12 microns, wherein more preferably according to (ii) the DV90 value of the particle size distribution of the refractory metal oxide support is in the range of 10 to 12 microns, wherein preferably the particles size distribution is measured by light scattering, more preferably according to reference example 1.

It is preferred that according to (ii) the catalyst coating of the DOC contains in addition to the refractory metal oxide support a binder, preferably in the range of from 2 to 7 wt.-% calculated on the basis of the total dry weight components present in the individual layer, more preferably in the range of 3 to 6 wt.-%, wherein more preferably the binder comprises, preferably consists of, one or more of zirconia, titania, alumina, silica, and mixtures thereof, more preferably one or more of zirconia, alumina and mixtures thereof, wherein more preferably zirconia is contained in the catalyst coating as a binder.

It is preferred that according to (ii) the total loading of the catalyst coating present in the DOC is in the range of from 31 g/L to 183 g/L (0.5 g/in³ to 3 g/in³) calculated in the total dry weight basis of all components present in the inlet coating and outlet coating, preferably in the range of from 46 g/L to 153 g/L (0.75 g/in³ to 2.5 g/in³), more preferably in the range of from 61 g/L to 140 g/L (1.0 g/in³to 2.3 g/in³), more preferably in the range of from 67 g/L to 110 g/L (1.1 g/in³to 1.8 g/in³), more preferably in the range of from 73 g/L to 104 g/L (1.2 g/in³to 1.7 g/in³), and more preferably in the range of from 79 g/L to 92 g/L (1.3 g/in³ to 1.5 g/in³).

It is preferred that according to (ii) the catalyst coating is divided into a catalytic inlet coating defining an upstream zone and a catalytic outlet coating defining a downstream zone,
wherein the substrate of the DOC has an inlet end, an outlet end, a substrate axial length extending between the inlet end and the outlet end, and a plurality of passages defined by internal walls of the substrate;
wherein the internal walls of the plurality of passages comprise the catalytic inlet coating that extends from the inlet end to an inlet coating end, thereby defining an inlet coating length, wherein the inlet coating length is x % of the substrate axial length, with 0 < x < 100;
wherein the internal walls of the plurality of passages comprise the outlet coating that extends from the outlet end to an outlet coating end, thereby defining an outlet coating length,
wherein the outlet coating length is (100-x)% of the substrate axial length;
wherein the inlet coating length defines an upstream zone of the DOC and the outlet coating length defines a downstream zone of the DOC;
wherein the inlet coating comprises one or more platinum group metals, wherein the one or more platinum group metals comprise, preferably consist of, platinum, preferably platinum and palladium;
wherein the outlet coating comprises one or more platinum group metals, wherein the one or more platinum group metals comprise, preferably consist of, platinum, preferably platinum and palladium.

It is preferred that according to (ii) the loading of the total amount of platinum group metals contained in the inlet coating of the DOC is in the range of from 0.18 to 2.83 g/L (5 to 80 g/ft³), preferably in the range of from 0.53 to 2.65 g/L (15 to 75 g/ft³), more preferably in the range of from 0.71 to 2.47 g/L (20 to 70 g/ft³), more preferably in the range of from 1.06 to 2.30 g/L(30 to 65 g/ft3), more preferably in the range of from 1.41 to 2.12 g/L (40 to 60 g/ft³); wherein more preferably according to (ii) the loading of the total amount of platinum group metals contained in the inlet coating is in the range of from greater than 1.77 g/L (50 g/ft³) to less than 2.12 g/L (60 g/ft³).

It is preferred that according to (ii) the inlet coating of the DOC has a Pt/Pd weight ratio in the range of from 5:1 to 1:5, preferably in the range of from 4:1 to 1:4, more preferably in the range of from 2:1 to 1:3, more preferably in the range of from 1:1 to 1:2, and more preferably in the range of from 1 : 1.4 to 1 : 1.8.

It is preferred that according to (ii) the loading of the total amount of platinum group metals, calculated as elemental platinum group metal, contained in the outlet coating of the DOC is in the range of from 0.04 to 2.47 g/L (1 to 70 g/ft³), preferably in the range of from 0.04 to 1.77 g/L(1 to 50 g/ft³), more preferably in the range of from 0.04 to 1.06 g/L (1 to 30 g/ft³), more preferably in the range of from 0.04 to 0.71 g/L (1 to 20 g/ft³), more preferably in the range of from 0.07 to 0.53 g/L (2 to 15 g/ft³), more preferably in the range of from 0.11 to 0.28 g/L (3 to 8 g/ft³); wherein more preferably according to (ii) the loading of the total amount of platinum group metals, calculated as elemental platinum group metal, contained in the outlet coating is in the range of from greater than 0.14 g/L (4 g/ft³) to less than 0.21 g/L (6 g/ft³).

It is preferred that according to (ii) the outlet coating of the DOC has a Pt/Pd weight ratio in the range of from 10:1 to 1:0, preferably in the range of from 5:1 to 1:1, more preferably in the range of from 4:1 to 2:1, and more preferably in the range of from 3.5:1 to 2.5:1.

It is preferred that the according to (ii) the inlet coating length x as % of the substrate axial length of the substrate of the DOC is in the range of from 5 to 80, preferably in the range of from 10 to 70, more preferably in the range of from 15 to 60, more preferably in the range of from 20 to 60, more preferably in the range of from 25 to 55, more preferably in the range of from 30 to 50, and more preferably in the range of from 35 to 45.

It is preferred that according to (ii), the inlet coating and/or outlet coating of the DOC do not contain platinum group metals other than Pt and/or Pd beyond contaminants less than 2% by weight of the total sum weight of Pt and Pd, preferably less than 1% by weight of the total sum weight of Pt and Pd, and more preferably less than 0.5% by weight of the total sum weight of Pt and Pd.

It is preferred that according to (ii) the internal walls of the inlet and outlet passages of the DOC comprise an undercoat that extends from the inlet end coating length to the outlet end coating length of the substrate.

It is preferred that according to (ii) the undercoat of the DOC comprises, optionally consists of, one or more of pseudoboehmite, y-alumina, alumina, silica, lanthana, zirconia, titania, ceria, baria, and mixtures thereof, preferably one or more of pseudoboehmite, y-alumina, alumina, silica, lanthana, and mixtures thereof, more preferably the undercoat comprises, optionally consists of, pseudoboehmite.

It is preferred that according to (ii) no platinum group metals are intentionally present in the undercoat of the DOC.

It is preferred that according to (ii) the undercoat of the DOC has a DV90 value of the particle size distribution in the range of from 0.1 to 25 microns, preferably in the range of from 5 to 15 microns, more preferably in the range of from 7 to 13 microns, more preferably in the range of from 8 to 12 microns; wherein more preferably according to (ii) the undercoat has a DV90 value of the particle size distribution in the range of 9 to 11 microns, wherein preferably the particles size distribution is measured by light scattering, more preferably according to reference example 1.

It is preferred that according to (ii) the undercoat of the DOC contains less than 0.1 wt.-% of platinum group metals calculated on the basis of the total dry mass of the undercoat, preferably less than 0.01 wt.-% of platinum group metals.

It is preferred that according to (ii) the substrate of the DOC has an undercoat loading in the range of 15 to 92 g/L (0.25 to 1.5 g/in³), preferably in the range of 31 to 76 g/L (0.5 to 1.25 g/in³), and more preferably in the range of 55 to 67 g/L (0.9 to 1.1 g/in³).

It is preferred that according to (ii) no layer is between the undercoat and the substrate of the DOC.

It is preferred that according to (ii) no layer is between the undercoat and the inlet and/or outlet coating containing platinum group metals of the DOC.

It is preferred that according to (ii) the total loading of platinum group metals, calculated as elemental platinum group metal, present in the DOC is in the range of from 0.35 g/L to 1.77 g/L (10 g/ft³ to 50 g/ft³), preferably in the range of from 0.53 g/L to 1.59 g/L (15 g/ft³ to 45 g/ft³), more preferably in the range of from 0.71 g/L to 1.41 g/L (20 g/ft³ to 40 g/ft³), more preferably in the range of from 0.74 g/L to 1.02 g/L (21 g/ft³ to 29 g/ft³); wherein more preferably according to (ii) the total loading of platinum group metals, calculated as elemental platinum group metal, present in the DOC is in the range of from greater than 0.81 g/L (23 g/ft³) to less than 0.88 g/L (25 g/ft³).

It is preferred that according to (ii) the DOC has a total length, preferably substrate length, in the range of from 2.54 to 25.4 cm (1 to 10 inches), preferably in the range of from 3.81 to 20.32 cm (1.5 to 8 inches), more preferably in the range of from 5.08 to 17.78 cm (2 to 7 inches), more preferably in the range of from 5.08 to 15.24 cm (2 to 6 inches), more preferably in the range of from 7.62 to 12.7 cm (3 to 5 inches).

It is preferred that according to (ii) the DOC has a total width, preferably substrate width, in the range of from 10.16 to 43.18 cm (4 to 17 inches), preferably in the range of from 17.78 to 38.10 cm (7 to 15 inches), more preferably in the range of from 20.32 to 35.56 cm (8 to 14 inches), more preferably in the range of from 22.86 to 33.02 cm (9 to 13 inches), more preferably in the range of from 22.86 to 27.94 cm (9 to 11 inches).

It is preferred that the zeolitic material comprised in the catalyst coating of the MFC according to (iv) has a framework structure of the type AEI, GME, CHA, MFI, BEA, FAU, MOR or mixtures of two or more thereof, preferably a framework structure of the type AEI, CHA, BEA or mixtures of two or more thereof, more preferably a framework structure of the type CHA or AEI, more preferably a framework structure of the type CHA.

It is preferred that the zeolitic material comprised in the catalyst coating of the MFC according to (iv) comprises copper, wherein the amount of copper comprised in the zeolitic material, calculated as CuO, is preferably in the range of from 0.1 to 10.0 weight-%, more preferably in the range of from 2.0 to 7.0 weight-%, more preferably in the range of from 2.5 to 5.5 weight-%, more preferably in the range of from 2.5 to 3.5 weight-%, based on the total weight of the zeolitic material; wherein the amount of iron comprised in the zeolitic material, calculated as Fe₂O₃, is preferably in the range of from 0 to 0.01 weight-%, more preferably in the range of from 0 to 0.001 weight-%, more preferably in the range of from 0 to 0.0001 weight-%, based on the total weight of the zeolitic material.

It is preferred that from 95 to 100 weight-%, preferably from 98 to 100 weight-%, more preferably from 99 to 100 weight-% of the framework structure of the zeolitic material consist to Si, Al, O, and optionally one or more of H and P, wherein in the framework structure, the molar ratio of Si to Al, calculated as molar SiO₂ — Al₂O₃, is preferably in the range of from 2:1 to 50:1, more preferably in the range of from 4:1 to 45:1, more preferably in the range of from 10:1 to 40: 1, more preferably in the range of from 15: 1 to 30: 1.

It is preferred that the zeolitic material comprised in the catalyst coating of the MFC according to (iv) comprises iron, wherein the amount of iron comprised in the zeolitic material, calculated as Fe₂O₃, is preferably in the range of from 0.1 to 10.0 weight-%, more preferably in the range of from 1.0 to 7.0 weight-%, more preferably in the range of from 2.5 to 5.5 weight-% based on the total weight of the zeolitic material, and wherein preferably from 95 to 100 weight-%, more preferably from 98 to 100 weight-%, more preferably from 99 to 100 weight-% of the framework structure of the zeolitic material consist to Si, Al, O, and optionally one or more of H and P, wherein in the framework structure, the molar ratio of Si to Al, calculated as molar SiO₂ — Al₂O₃, is preferably in the range of from 2:1 to 50:1, more preferably in the range of from 4:1 to 45:1, more preferably in the range of from 10:1 to 40: 1, more preferably in the range of from 15: 1 to 30: 1.

It is preferred that the zeolitic material comprised in the catalyst coating of the MFC according to (iv), preferably which has a framework type CHA, has a mean crystallite size of at least 0.5 micrometer, preferably in the range of from 0.5 to 1.5 micrometers, more preferably in the range of from 0.6 to 1.0 micrometer, more preferably in the range of from 0.6 to 0.8 micrometer determined via scanning electron microscopy.

It is preferred that the catalyst coating of the MFC according to (iv) further comprises a metal oxide binder, wherein the metal oxide binder preferably comprises one or more of zirconia, alumina, titania, silica, and a mixed oxide comprising two or more of Zr, Al, Ti, and Si, more preferably comprises one or more of alumina and zirconia, more preferably comprises zirconia; wherein the coating comprises the metal oxide binder with a loading in the range of from 1.22 to 12 g/L (0.02 to 0.2 g/in³), preferably in the range of from 4.88 to 11 g/L (0.08 to 0.18 g/in³).

It is preferred that in (iv) the one or more platinum group metals are supported on a refractory metal oxide, wherein the refractory metal oxide comprised in the catalyst coating of the MFC according to (iv) comprises one or more of zirconia, silica, alumina and titania, preferably one or more of zirconia and alumina.

It is preferred that according to (iv), the one or more platinum group metals are supported on zirconia.

It is preferred that from 90 to 100 weight-%, preferably from 95 to 100 weight-%, more preferably from 99 to 100 weight-% of the refractory metal oxide comprised in the catalyst coating of the MFC according to (iv) consist of zirconia.

It is preferred that the catalyst coating of the MFC according to (iv) comprises the zeolitic material with a loading in the range of from 61 to 275 g/L (1.0 to 4.5 g/in³), preferably in the range of from 92 to 244 g/L (1.5 to 4.0 g/in³), more preferably in the range of from 122 to 214 g/L (2.0 to 3.5 g/in³), more preferably in the range of from 128 to 183 g/L (2.1 to 3 g/in³), more preferably in the range of from 128 to 159 g/L (2.1 to 2.6 g/in³).

It is preferred that the catalyst coating of the MFC according to (iv) comprises the one or more platinum group metals at a loading, calculated as elemental platinum group metal, in the range of from 0.04 to 2.83 g/L (1 to 80 g/ft³), preferably in the range of from 0.53 to 2.12 g/L (15 to 60 g/ft³), more preferably in the range of from 0.71 to 1.77 g/L (20 to 50 g/ft³), more preferably in the range of from 0.88 to 1.59 g/L (25 to 45 g/ft³), more preferably in the range of from 0.88 to 1.24 g/L (25 to 35 g/ft³).

It is preferred that from 95 to 100 weight-%, preferably from 98 to 100 weight-%, more preferably from 99 to 100 weight-%, more preferably from 99.5 to 100 weight-% of the catalyst coating of the MFC according to (iv) comprise, preferably consist of, the one or more platinum group metals supported on a refractory metal oxide, wherein from 99 to 100 weight-% of said refractory metal oxide consist of zirconium and oxygen, preferably of zirconia, a copper containing zeolitic material having a framework structure of the type CHA, and preferably a metal oxide binder as defined in embodiment 41.

It is preferred that from 0 to 0.0035 g/l, preferably from 0 to 0.00035 g/l, more preferably from 0 to 0.000035 g/l, more preferably from 0 to 0.0000035 g/l of one or more of platinum, iridium, osmium and rhodium are comprised in the coating of the MFC according to (iv), wherein more preferably from 0 to 0.0000035 g/l of platinum, iridium, osmium and rhodium are comprised in the coating of the MFC according to (iv).

It is preferred that the catalyst coating of the MFC according to (iv) is free of platinum, preferably free of platinum and rhodium, more preferably free of platinum, iridium, osmium and rhodium.

It is preferred that from 0 to 2 weight-%, preferably from 0 to 1 weight-%, more preferably from 0 to 0.1 weight-% of the refractory metal oxide supporting the one or more platinum group metals comprised in the catalyst coating of the MFC according to (iv) consist of ceria and alumina, wherein more preferably from 0 to 0.1 weight-% of the refractory metal oxide comprised in the catalyst coating of the MFC according to (iv) consists of ceria, alumina, titania, lanthana and baria.

It is preferred that the refractory metal oxide supporting the one or more platinum group metals comprised in the catalyst coating of the MFC according to (iv) is free of ceria and alumina, preferably free of ceria, alumina and titania, more preferably free of ceria, alumina, titania, lanthana and baria.

It is preferred that the catalyst coating of the MFC according to (iv) comprises a copper containing zeolitic material having a framework structure of the type CHA and palladium supported on zirconia comprised as a single coat, wherein the single coat is disposed on at least a portion of the internal walls of the substrate of the MFC according to (iv).

It is preferred that the catalyst coating of the MFC according to (iv) comprises a copper containing zeolitic material having a framework structure of the type CHA and the one or more platinum group metals are supported on a refractory metal oxide comprising one or more of zirconia, alumina and titania, preferably one or more of alumina and zirconia, and the catalyst coating consists of an overcoat, wherein the copper containing zeolitic material having a framework structure of the type CHA is comprised, and an undercoat, wherein the platinum group metal supported on an refractory metal oxide is comprised, wherein the undercoat is disposed on at least a portion of the surface of the internal walls of the substrate of the MFC according to (iv) and the overcoat is disposed on the undercoat.

It is preferred that the platinum group metal comprised in the undercoat of the MFC according to (iv) is palladium.

It is preferred that the refractory metal oxide comprised in the undercoat of the MFC according to (iv) comprises, preferably consists of, one or more of alumina and zirconia.

It is preferred that from 60 to 100 weight-%, preferably from 70 to 90 weight-%, more preferably from 75 to 85 weight-% of the refractory metal oxide comprised in the undercoat of the MFC according to (iv) consist of alumina.

It is preferred that the undercoat of the MFC according to (iv) comprises palladium at a loading, calculated as elemental palladium, in the range of from 0.04 to 1.77 g/L (1 to 50 g/ft³), preferably in the range of from 0.18 to 1.06 g/L (5 to 30 g/ft³), more preferably in the range of from 0.35 to 0.88 g/L (10 to 25 g/ft³), more preferably in the range of from 0.42 to 0.54 g/L (12 to 18 g/ft³).

It is preferred that from 95 to 100 weight-%, preferably from 98 to 100 weight-%, more preferably from 99 to 100 weight-%, more preferably from 99.5 to 100 weight-% of the undercoat of the MFC according to (iv) comprises, preferably consist of, palladium supported on a refractory metal oxide, wherein from 99.5 to 100 weight-% of said refractory metal oxide comprises, more preferably consists of, one or more of alumina and zirconia.

It is preferred that the overcoat of the MFC according to (iv) comprises the zeolitic material at a loading in the range of from 61 to 275 g/L (1 to 4.5 g/in³), preferably in the range of from 92 to 244 g/L (1.5 to 4 g/in³), more preferably in the range of from 122 to 244 g/L (2 to 4 g/in³), more preferably in the range of from 153 to 214 g/L (2.5 to 3.5 g/in³).

It is preferred that from 95 to 100 weight-%, preferably from 98 to 100 weight-%, more preferably from 99 to 100 weight-%, more preferably from 99.5 to 100 weight-% of the undercoat of the MFC according to (iv) comprises, preferably consists of, palladium supported on a refractory metal oxide, wherein from 99.5 to 100 weight-% of said refractory metal oxide comprises, more preferably consists of, one or more of alumina and zirconia; and wherein from 95 to 100 weight-%, preferably from 98 to 100 weight-%, more preferably from 99 to 100 weight-%, more preferably from 99.5 to 100 weight-% of the overcoat of the MFC according to (iv) comprises, preferably consists of, a copper containing zeolitic material having a framework structure of the type CHA, and preferably a metal oxide binder as defined in claim 41.

It is preferred that from 0 to 0.0035 g/l, preferably from 0 to 0.00035 g/l, more preferably from 0 to 0.000035 g/l of one or more of platinum, iridium, osmium and rhodium are comprised in the undercoat of the MFC according to (iv), wherein more preferably from 0 to 0.000035 g/l of platinum, iridium, osmium and rhodium are comprised in the undercoat of the MFC according to (iv).

It is preferred that the undercoat of the MFC according to (iv) is free of platinum and rhodium, preferably free of platinum, rhodium, iridium and osmium.

It is preferred that the MFC according to (iv) consists of a coating disposed on a substrate.

It is preferred that the substrate of the MFC according to (iv) comprises a ceramic or metallic substance.

It is preferred that the substrate of the MFC according to (iv) comprises, preferably consists of, a ceramic substance, wherein the ceramic substance preferably comprises, more preferably consists of, one or more of an alumina, a silica, a silicate, an aluminosilicate, preferably a cordierite or a mullite, an aluminotitanate, a silicon carbide, a zirconia, a magnesia, preferably a spinel, and a titania, more preferably one or more of a silicon carbide and a cordierite, more preferably a cordierite; or wherein the substrate of the MFC according to (iv) comprises, preferably consists of, a metallic substance, wherein the metallic substance preferably comprises, more preferably consists of, oxygen and one or more of iron, chromium and aluminum.

It is preferred that the substrate of the MFC according to (iv) is a monolith, preferably a honeycomb monolith, more preferably a flow-through honeycomb monolith.

It is preferred that the MFC according to (iv) has a length, preferably a substrate length, in the range of from 2.54 to 25.4 cm (1 to 10 inches), preferably in the range of from 3.81 to 20.32 cm (1.5 to 8 inches), more preferably in the range of from 5.08 to 17.78 cm (2 to 7 inches), more preferably in the range of from 5.08 to 15.24 cm (2 to 6 inches), more preferably in the range of from 5.08 to 10.16 cm (2 to 4 inches).

It is preferred that the MFC according to (iv) has a width, preferably a substrate width, in the range of from 10.16 to 43.18 cm (4 to 17 inches), preferably in the range of from 17.78 to 38.10 cm (7 to 15 inches), more preferably in the range of from 20.32 to 35.56 cm (8 to 14 inches), more preferably in the range of from 22.86 to 33.02 cm (9 to 13 inches), more preferably in the range of from 22.86 to 27.94 cm (9 to 11 inches).

It is preferred that the catalyst coating of the MFC according to (iv) is disposed on the internal walls of the substrate of the MFC according to (iv) over 20 to 100 %, preferably over 50 to 100 %, more preferably over 75 to 100 %, more preferably over 95 to 100 %, more preferably over 99 to 100 % of the substrate length.

The present invention also relates to a method for the simultaneous selective catalytic reduction of NOx, the oxidation of hydrocarbon, the oxidation of nitrogen monoxide and the oxidation of ammonia, comprising
(1) providing an exhaust gas stream from a diesel engine comprising one or more of NOx, ammonia, nitrogen monoxide and a hydrocarbon;
(2) passing the exhaust gas stream provided in (1) through the exhaust gas system according to any one of the particular and preferred embodiments of the exhaust gas treatment system according to the present invention as described in the present application.

Furthermore, the present invention relates to a method for preparing an exhaust gas treatment system according to any one of the particular and preferred embodiments of the exhaust gas treatment system according to the present invention as described in the present application, said method comprising preparing a diesel oxidation catalyst (DOC) according to a process comprising
(a) preparing a first slurry comprising a platinum group metal, a refractory metal oxide support, and water,
(b) providing a substrate,
(c) disposing the first slurry obtained in (a) on the substrate according to (b), coating the internal walls of the inlet passages such that the inlet coating extends from the inlet end to an inlet coating end whereby an inlet coating length is defined, wherein the inlet coating length is x % of the substrate axial length with 0 < x < 100, obtaining a slurry-treated substrate;
(d) drying the slurry-treated substrate obtained in (c), obtaining a substrate having an inlet coating disposed thereon;
(e) calcining the slurry-treated substrate obtained in (c), obtaining an inlet coated substrate,
(f) preparing a second slurry comprising a platinum group metal, a refractory metal oxide support, and water,
(g) disposing the second slurry obtained according to (f) on the substrate obtained according to (e), coating the internal walls of the outlet passages such that the outlet coating extends from the outlet end to an outlet coating end whereby an outlet coating length is defined, wherein the outlet coating length is (100-x)% of the substrate axial length, obtaining an inlet coated and outlet slurry treated substrate,
(h) drying the slurry-treated substrate obtained in (g), obtaining a substrate having inlet and outlet coatings disposed thereon,
(i) calcining the slurry-treated substrate obtained in (g), for obtaining a DOC, preferably a DOC according to (ii) comprised in the exhaust gas treatment system according to any one of the particular and preferred embodiments of the exhaust gas treatment system according to the present invention as described in the present application.

It is preferred that step (a) and/or step (f) further comprises the steps of
(1.1) providing a refractory metal oxide support comprising, preferably consisting of, pseudoboehmite, alumina, y-alumina, silica stabilized titania, lanthana, lanthana stabilized alumina, silica stabilized alumina, zirconia, titania, ceria, ceria-zirconia, aluminosilicate, silica, rare-earth metal sesquioxide, and mixtures thereof, preferably pseudoboehmite, alumina, y-alumina, titania, silica stabilized titania, silica stabilized alumina, and mixtures thereof, preferably pseudoboehmite and/or silica stabilized alumina, preferably an equal weight mixture of pseudoboehmite and 2 to 6 wt.-% silica stabilized alumina; preferably wherein the refractory metal oxide support is acidic, preferably having a pH in the range of 2 to less than 7, wherein preferably the pH is adjusted by addition of an inorganic acid nitric acid and/or an organic acid consisting of one or more acetic, propionic, oxalic, malonic, succinic, glutamic, adipic, maleic, fumaric, phthalic, tartaric, and citric acid, preferably acetic acid;
(1.2) adding a platinum group metal by means of incipient wetness, wherein preferably the platinum group metal comprises, preferably consists of, platinum, preferably palladium and platinum, obtaining a platinum group metal supported on a refractory metal oxide, preferably a first platinum group metal supported on a refractory metal oxide;
(1.3) optionally repeating steps (1.1) and (1.2) with the same refractory metal oxide support according to (1.1) and a different platinum group metal according to (1.2), obtaining a second platinum group metal supported on a refractory metal oxide and mixing the first and second platinum group metals supported on a refractory metal oxide, obtaining a mechanical mixture of first and second platinum group metals supported on a refractory metal oxide;
(1.4) optionally adding barium salt and/or a lanthanum salt to the platinum group metal supported on a refractory metal oxide obtained from (1.2) or the mechanical mixture of first and second platinum group metals supported on a refractory metal oxide from (1.3), obtaining a platinum group metal supported on a refractory metal oxide containing barium and/or lanthanum or a mechanical mixture of first and second platinum group metals supported on a refractory metal oxide containing barium and/or lanthanum,
(1.5) optionally adding a binder to the platinum group metal supported on a refractory metal oxide obtained from (1.2) or (1.4) or the mechanical mixture of first and second platinum group metals supported on a refractory metal oxide from (1.3) or (1.4), wherein preferably the binder comprises, preferably consists of, one or more of zirconia, titania, alumina, silica, and mixtures thereof, preferably zirconia, alumina and mixtures thereof, preferably zirconia;
(1.6) optionally milling the platinum group metal supported on a refractory metal oxide obtained from (1.2), (1.4) or (1.5) or the mechanically mixed platinum group metals supported on a refractory metal oxide obtained from (1.3), (1.4) or (1.5), obtaining a platinum group metal supported on a refractory metal oxide or mechanical mixture of platinum group metals supported on a refractory metal oxide having a DV90 value of the particle size distribution in the range of 0.1 to 25 microns, preferably in the range of 1 to 20 microns, more preferably in the range of 2 to 18 microns, more preferably in the range of 3 to 17 microns, more preferably in the range of 4 to 16 microns, more preferably in the range of 5 to 15 microns, and more preferably in the range of 7 to 12 microns; wherein more preferably the DV90 value of the particle size distribution of the refractory metal oxide support or the mechanically mixed platinum group metals supported on a refractory metal oxide is in the range of 10 to 12 microns, wherein preferably the particles size distribution is measured by light scattering, more preferably according to reference example 1;
(1.7) Dispersing the platinum group metal supported on a refractory metal oxide obtained from (1.2), (1.4), (1.5) or (1.6) or the mechanical mixture of platinum group metals supported on a refractory metal oxide obtained from (1.3), (1.4), (1.5) or (1.6) in water, thereby obtaining a first slurry according to step (a) and/or second slurry according to step (f).

It is preferred that step (a) and/or step (f) further comprise adding a binder, preferably in the range of from 2 to 7 wt.-% calculated on the basis of the total dry weight components present in the individual layer, preferably in the range of 3 to 6 wt.-%, wherein preferably the binder comprises, preferably consists of, one or more of zirconia, titania, alumina, silica, and mixtures thereof, preferably zirconia, alumina and mixtures thereof, preferably zirconia.

It is preferred that the substrate according to (b) comprises, preferably consists of, a ceramic substance, wherein the ceramic substance preferably comprises, more preferably consists of, one or more of an alumina, a silica, a silicate, an aluminosilicate, preferably a cordierite or a mullite, an aluminotitanate, a silicon carbide, a zirconia, a magnesia, preferably a spinel, and a titania, more preferably one or more of a silicon carbide and a cordierite, more preferably a cordierite.

It is preferred that the substrate according to (b) comprises, preferably consists of, a metallic substance, wherein the metallic substance preferably comprises, more preferably consists of, oxygen and one or more of iron, chromium and aluminum.

It is preferred that according to (ii) the substrate of the DOC is a monolith, preferably a honeycomb monolith, more preferably a flow-through honeycomb monolith.

It is preferred that the substrate provided in step (b) has an undercoat, preferably obtained by the steps comprising
(b.1) providing a refractory metal oxide support comprising, optionally consisting of, one or more of pseudoboehmite, y-alumina, alumina, silica, lanthana, zirconia, titania, ceria, baria, and mixtures thereof, preferably one or more of pseudoboehmite, y-alumina, alumina, silica, lanthana, and mixtures thereof, more preferably the undercoat comprises, optionally consists of, pseudoboehmite;
(b.2) optionally milling the refractory metal oxide support provided in (b.1), preferably obtaining a refractory metal oxide support having a DV90 value of the particle size distribution in the range of from 0.1 to 25 microns, preferably in the range of from 5 to 15 microns, more preferably in the range of from 7 to 13 microns, more preferably in the range of from 8 to 12 microns; wherein more preferably obtaining a refractory metal oxide support having a DV90 value of the particle size distribution in the range of 9 to 11 microns, wherein preferably the particles size distribution is measured by light scattering, more preferably according to reference example 1;
(b.3) coating the entire length of the inlet and outlet of the substrate with the refractory metal oxide support obtained according to (b.1) or (b.2), obtaining an undercoated substrate;
(b.4) optionally drying and/or calcining the undercoated substrate according to (b.3), obtaining a dried and/or calcined undercoated substrate.

It is preferred that the substrate provided in (b) has an undercoat loading in the range of 15 to 92 g/L (0.25 to 1.5 g/in³), preferably in the range of 31 to 76 g/L (0.5 to 1.25 g/in³), and more preferably in the range of 55 to 67 g/L (0.9 to 1.1 g/in³).

It is preferred that according to step (b) no platinum group metals are intentionally present in the undercoat of the DOC.

It is preferred that according to step (b) the undercoat of the DOC contains less than 0.1 wt.-% of platinum group metals calculated on the basis of the total dry mass of the undercoat, preferably less than 0.01 wt.-% of platinum group metals.

It is preferred that according to step (b) no layer is between the undercoat and the substrate of the DOC.

It is preferred that in step (c) the internal walls of the inlet passages are coated such that the inlet coating extends from the inlet end to an inlet coating end whereby an inlet coating length is defined, wherein the inlet coating length is x as % of the substrate axial length of the substrate of the DOC, and is in the range of from 5 to 80, preferably in the range of from 10 to 70, more preferably in the range of from 15 to 60, more preferably in the range of from 20 to 60, more preferably in the range of from 25 to 55, more preferably in the range of from 30 to 50, and more preferably in the range of from 35 to 45.

The present invention also relates to a method for preparing an exhaust gas treatment system according to any one of the particular and preferred embodiments of the exhaust gas treatment system according to the present invention as described in the present application, said method comprising preparing a multifunctional catalyst (MFC) according to a process comprising
(a′) preparing a slurry comprising palladium, an oxidic material comprising one or more of zirconium and aluminum, and water,
(b′) disposing the slurry obtained in (a) on a substrate, obtaining a slurry-treated substrate;
(c′) optionally, drying the slurry-treated substrate obtained in (b′), obtaining a substrate having a coating disposed thereon;
(d′) calcining the slurry-treated substrate obtained in (b′), preferably the dried slurry-treated substrate obtained in (c′), for obtaining an MFC catalyst, preferably an MFC according to (iv) comprised in the exhaust gas treatment system according to any one of the particular and preferred embodiments of the exhaust gas treatment system according to the present invention as described in the present application.

It is preferred that (a′) comprises
(a′. 1) mixing an aqueous solution of a palladium precursor, preferably an aqueous palladium nitrate solution, with an oxidic material comprising one or more of zirconium and aluminum, obtaining palladium supported on the oxidic material;
(a′.2) calcining the palladium supported on the oxidic material obtained in (a′.1);
(a′.3) mixing the calcined palladium supported on the oxidic material obtained in (a′.2) with a disposing adjuvant, preferably one or more of tartaric acid and monoethanolamine, more preferably tartaric acid and monoethanolamine.

It is preferred that (a′) further comprises

(a′.4) milling the mixture obtained in (a′.3) to a particle size Dv90, as determined according to Reference Example 1, in the range of from 1 to 20 micrometers, preferably in the range of from 5 to 15 micrometers, more preferably in the range of from 9 to 11 micrometers.

It is preferred that, according to (a′.1), the aqueous solution of a palladium precursor, preferably an aqueous palladium nitrate solution, is added dropwise to the oxidic material.

It is preferred that, according to (a′.2), the palladium supported on the oxidic material is calcined in gas atmosphere having a temperature in the range of from 490 to 690° C., preferably in the range of from 540 to 640° C., more preferably in the range of from 570 to 610° C.

It is preferred that, according to (a′.2), the palladium supported on the oxidic material is calcined in gas atmosphere for a duration in the range of from 2 to 6 hours, preferably in the range of from 3 to 5 hours.

It is preferred that disposing the slurry on a substrate in (b′), wherein the substrate has a substrate length, comprises disposing the slurry on 20 to 100 %, preferably on 50 to 100 %, more preferably from on 75 to 100 %, more preferably on 95 to 100 %, more preferably on 99 to 100 % of the substrate length.

It is preferred that, according to (c′), the slurry-treated substrate is dried in gas atmosphere having a temperature in the range of from 90 to 200° C., preferably in the range of from 110 to 180° C., more preferably in the range of from 120 to 160° C., wherein more preferably the slurry-treated substrate is dried in gas atmosphere for a duration in the range of from 5 to 300 minutes, more preferably in the range of 10 to 120 minutes, more preferably in the range of from 20 to 60 minutes.

It is preferred that, according to (c′), the slurry-treated substrate is dried in gas atmosphere having a temperature in the range of from 90 to 200° C., preferably in the range of from 100 to 150° C., more preferably in the range of from 110 to 130° C., for a duration preferably in the range of from 5 to 300 minutes, more preferably in the range of from 5 to 60 minutes, more preferably in the range of from 7 to 20 minutes; and further dried in gas atmosphere having a temperature in the range of from 90 to 200° C., preferably in the range of from 140 to 180° C., more preferably in the range of from 150 to 170° C., for a duration preferably in the range of from 5 to 300 minutes, more preferably 10 to 80 minutes, more preferably in the range of from 20 to 40 minutes.

It is preferred that, according to (d′), the slurry-treated substrate obtained in (b′), preferably the dried slurry-treated substrate obtained in (c′), is calcined in gas atmosphere having a temperature in the range of from 300 to 600° C., preferably in the range of from 400 to 500° C., more preferably in the range of from 425 to 475° C.

It is preferred that, according to (d′), the slurry-treated substrate obtained in (b′), preferably the dried slurry-treated substrate obtained in (c′), is calcined in gas atmosphere for a duration in the range of from 5 to 120 minutes, preferably in the range of from 10 to 90 minutes, more preferably in the range of from 15 to 50 minutes, more preferably in the range of from 20 to 40 minutes.

It is further preferred that the method for preparing an exhaust gas treatment system according to any one of the particular and preferred embodiments of the exhaust gas treatment system according to the present invention as described in the present application comprises preparing a multifunctional catalyst (MFC) according to a process consisting of
(a′) preparing a slurry comprising palladium, an oxidic material comprising one or more of zirconium and aluminum, and water,
(b′) disposing the slurry obtained in (a′) on a substrate, obtaining a slurry-treated substrate;
(c′) drying the slurry-treated substrate obtained in (b′), obtaining a substrate having a coating disposed thereon;
(d′) calcining the dried slurry-treated substrate obtained in (c′), obtaining an MFC catalyst, preferably an MFC according to (iv) comprised in the exhaust gas treatment system according to any one of the particular and preferred embodiments of the exhaust gas treatment system according to the present invention as described in the present application.

The present invention also relates to a method for preparing an exhaust gas treatment system according to any one of the particular and preferred embodiments of the exhaust gas treatment system according to the present invention as described in the present application, wherein said method comprises preparing a diesel oxidation catalyst (DOC) according to any of the the particular and preferred embodiments according to the present invention as described in the present application relating the method of preparing said DOC, and further comprises preparing a multifunctional catalyst (MFC) according to any of the particular and preferred embodiments according to the present invention as described in the present application relating the method of preparing said MFC.

According to the present invention, the term “platinum group metals” refers to the group of metals consisting of Pt, Pd, Rh, Ru, Os, and Ir, and preferably to the group of metals consisting of Pt, Pd, and Rh.

Within the meaning of the present invention, a close-coupled catalyst is distinguished from an underfloor catalyst in that it is located upstream and outside of the main catalyst box which comprises the MFC. In particular, it is preferred within the meaning of the present invention that a close-coupled catalyst, and in particular the close-coupled DOC according to particular and preferred embodiments of the present invention, is located in close proximity, preferably in closest proximity, to the lean burn engine.

The present invention is further illustrated by the following set of embodiments and combinations of embodiments resulting from the dependencies and back-references as indicated. In particular, it is noted that in each instance where a range of embodiments is mentioned, for example in the context of a term such as “any one of embodiments (1) to (4)”, every embodiment in this range is meant to be explicitly disclosed for the skilled person, i.e. the wording of this term is to be understood by the skilled person as being synonymous to “any one of embodiments (1), (2), (3), and (4)”.

Further, it is explicitly noted that the following set of embodiments is not the set of claims determining the extent of protection, but represents a suitably structured part of the description directed to general and preferred aspects of the present invention.

According to an embodiment (1), the present invention relates to an exhaust gas treatment system for treating exhaust gas from a lean burn combustion engine, wherein said exhaust gas comprises hydrocarbons and NOx, the exhaust gas treatment system comprising:
(i) a means for injecting hydrocarbons into an exhaust gas stream;
(ii) a diesel oxidation catalyst (DOC) comprising a substrate and a catalyst coating provided on the substrate, wherein the catalyst coating comprises one or more platinum group metals, wherein the one or more platinum group metals comprise, preferably consist of, platinum, preferably platinum and palladium;
(iii) a means for injecting a nitrogenous reducing agent into an exhaust gas stream; and
(iv) a multifunctional catalyst (MFC) comprising, preferably consisting of, an oxidation catalyst, and a selective catalytic reduction (SCR) catalyst for the selective catalytic reduction of NOx, wherein the MFC comprises a substrate and a catalyst coating provided on the substrate, wherein the catalyst coating comprises the oxidation catalyst and the SCR catalyst, wherein the oxidation catalyst comprises one or more platinum group metals, wherein the one or more platinum group metals comprise, preferably consist of, palladium and/or platinum, preferably palladium, and wherein the SCR catalyst comprises a zeolitic material loaded with copper and/or iron, preferably with copper;
wherein the means for injecting hydrocarbons, the DOC, the means for injecting a nitrogenous reducing agent, and the MFC are located in sequential order in a conduit for exhaust gas, wherein the means for injecting hydrocarbons into an exhaust gas stream is located upstream of the DOC, wherein the DOC is located upstream of the MFC, and wherein the means for injecting a nitrogenous reducing agent into the exhaust gas stream is located between the DOC and the MFC.

A preferred embodiment (2) concretizing embodiment (1) relates to said system, wherein no further component is located in the exhaust gas treatment system between the means for injecting hydrocarbons according to (i) and the DOC according to (ii), wherein preferably no further component is located in the exhaust gas treatment system between the means for injecting the hydrocarbons according to (i) and the DOC according to (ii) and between the DOC according to (ii) and the means for injecting a nitrogenous reducing agent according to (iii) and between the means for injecting a nitrogenous reducing agent according to (iii) and the MFC according to (iv).

A further preferred embodiment (3) concretizing embodiment (1) or (2) relates to said system, wherein the exhaust gas treatment system further comprises a lean burn engine located upstream of the DOC according to (ii).

A further preferred embodiment (4) concretizing embodiment (3) relates to said system, wherein the DOC according to (ii) is close-coupled to the lean burn engine, wherein preferably the lean burn engine is a diesel engine.

A further preferred embodiment (5) concretizing embodiment (3) or (4) relates to said system, wherein the lean burn engine acts as a means for injecting hydrocarbons into an exhaust gas stream according to (i) by producing an exhaust gas stream comprising controlled amounts of hydrocarbons, preferably by secondary fuel injection.

A further preferred embodiment (6) concretizing any one of embodiments (3) to (5) relates to said system, wherein a means for injecting hydrocarbons into an exhaust gas stream according to (i) is located between the lean burn engine and the DOC according to (ii).

A further preferred embodiment (7) concretizing any one of embodiments (3) to (6) relates to said system, wherein no further component is located in the exhaust gas treatment system between the lean burn engine and the means for injecting hydrocarbons according to (i), wherein preferably no further component is located in the exhaust gas treatment system between the lean burn engine and the means for injecting hydrocarbons according to (i) and between the means for injecting hydrocarbons according to (i) and the DOC according to (ii) and between the DOC according to (ii) and the means for injecting a nitrogenous reducing agent according to (iii) and between the means for injecting a nitrogenous reducing agent according to (iii) and the MFC according to (iv).

A further preferred embodiment (8) concretizing any one of embodiments (3) to (7) relates to said system, wherein no further component is located in the exhaust gas treatment system between the lean burn engine and the DOC according to (ii), wherein preferably no further component is located in the exhaust gas treatment system between the lean burn engine and the DOC according to (ii) and between the DOC according to (ii) and the means for injecting a nitrogenous reducing agent according to (iii) and between the means for injecting a nitrogenous reducing agent according to (iii) and the MFC according to (iv).

A further preferred embodiment (9) concretizing any one of embodiments (1) to (8) relates to said system, wherein according to (ii) the substrate of the DOC comprises, preferably consists of, a ceramic substance, wherein the ceramic substance preferably comprises, more preferably consists of, one or more of an alumina, a silica, a silicate, an aluminosilicate, preferably a cordierite or a mullite, an aluminotitanate, a silicon carbide, a zirconia, a magnesia, preferably a spinel, and a titania, more preferably one or more of a silicon carbide and a cordierite, and more preferably a cordierite.

A further preferred embodiment (10) concretizing any one of embodiments (1) to (9) relates to said system, wherein according to (ii) the substrate of the DOC comprises, preferably consists of, a metallic substance, wherein the metallic substance preferably comprises, more preferably consists of, oxygen and one or more of iron, chromium, and aluminum.

A further preferred embodiment (11) concretizing any one of embodiments (1) to (10) relates to said system, wherein according to (ii) the substrate of the DOC is a monolith, preferably a honeycomb monolith, more preferably a flow-through honeycomb monolith.

A further preferred embodiment (12) concretizing any one of embodiments (1) to (11) relates to said system, wherein according to (ii) the one or more platinum group metals present in the DOC are supported on one or more refractory metal oxides selected from the group consisting of, pseudoboehmite, alumina, y-alumina, lanthana, lanthana stabilized alumina, silica stabilized alumina, zirconia, titania, silica stabilized titania, ceria, ceria-zirconia, aluminosilicate, silica, and rare-earth metal sesquioxide, including mixtures thereof, preferably from the group consisting of pseudoboehmite, alumina, y-alumina, titania, silica stabilized titania and silica stabilized alumina, including mixtures thereof, wherein more preferably the one or more platinum group metals present in the DOC are supported on pseudoboehmite and/or silica stabilized alumina, more preferably on an equal weight mixture of pseudoboehmite and 2 to 6 wt.-% silica stabilized alumina.

A further preferred embodiment (13) concretizing any one of embodiments (11) to (12) relates to said system, wherein according to (ii) the DV90 value of the particle size distribution of the one or more refractory metal oxide supports is in the range of 0.1 to 25 microns, preferably in the range of 1 to 20 microns, more preferably in the range of 2 to 18 microns, more preferably in the range of 3 to 17 microns, more preferably in the range of 4 to 16 microns, more preferably in the range of 5 to 15 microns, more preferably in the range of 7 to 12 microns, wherein more preferably according to (ii) the DV90 value of the particle size distribution of the refractory metal oxide support is in the range of 10 to 12 microns, wherein preferably the particles size distribution is measured by light scattering, more preferably according to reference example 1.

A further preferred embodiment (14) concretizing any one of embodiments (11) to (13) relates to said system, wherein according to (ii) the catalyst coating of the DOC contains in addition to the refractory metal oxide support a binder, preferably in the range of from 2 to 7 wt.-% calculated on the basis of the total dry weight components present in the individual layer, more preferably in the range of 3 to 6 wt.-%, wherein more preferably the binder comprises, preferably consists of, one or more of zirconia, titania, alumina, silica, and mixtures thereof, more preferably one or more of zirconia, alumina and mixtures thereof, wherein more preferably zirconia is contained in the catalyst coating as a binder.

A further preferred embodiment (15) concretizing any one of embodiments (1) to (14) relates to said system, wherein according to (ii) the total loading of the catalyst coating present in the DOC is in the range of from 31 g/L to 183 g/L (0.5 g/in³ to 3 g/in³) calculated in the total dry weight basis of all components present in the inlet coating and outlet coating, preferably in the range of from 46 g/L to 153 g/L (0.75 g/in³ to 2.5 g/in³), more preferably in the range of from 61 g/L to 140 g/L (1.0 g/in³ to 2.3 g/in³), more preferably in the range of from 67 g/L to 110 g/L (1.1 g/in³ to 1.8 g/in³), more preferably in the range of from 73 g/L to 104 g/L (1.2 g/in³to 1.7 g/in³), and more preferably in the range of from 79 g/L to 92 g/L (1.3 g/in³ to 1.5 g/in³).

A further preferred embodiment (16) concretizing any one of embodiments (1) to (15) relates to said system, wherein according to (ii) the catalyst coating is divided into a catalytic inlet coating defining an upstream zone and a catalytic outlet coating defining a downstream zone,
wherein the substrate of the DOC has an inlet end, an outlet end, a substrate axial length extending between the inlet end and the outlet end, and a plurality of passages defined by internal walls of the substrate;
wherein the internal walls of the plurality of passages comprise the catalytic inlet coating that extends from the inlet end to an inlet coating end, thereby defining an inlet coating length, wherein the inlet coating length is x % of the substrate axial length, with 0 < x < 100;
wherein the internal walls of the plurality of passages comprise the outlet coating that extends from the outlet end to an outlet coating end, thereby defining an outlet coating length,
wherein the outlet coating length is (100-x)% of the substrate axial length;
wherein the inlet coating length defines an upstream zone of the DOC and the outlet coating length defines a downstream zone of the DOC;
wherein the inlet coating comprises one or more platinum group metals, wherein the one or more platinum group metals comprise, preferably consist of, platinum, preferably platinum and palladium;
wherein the outlet coating comprises one or more platinum group metals, wherein the one or more platinum group metals comprise, preferably consist of, platinum, preferably platinum and palladium.

A further preferred embodiment (17) concretizing embodiment (16) relates to said system, wherein according to (ii) the loading of the total amount of platinum group metals contained in the inlet coating of the DOC is in the range of from 0.18 to 2.83 g/L (5 to 80 g/ft³), preferably in the range of from 0.53 to 2.65 g/L (15 to 75 g/ft³), more preferably in the range of from 0.71 to 2.47 g/L (20 to 70 g/ft³), more preferably in the range of from 1.06 to 2.30 g/L (30 to 65 g/ft³), more preferably in the range of from 1.41 to 2.12 g/L (40 to 60 g/ft³); wherein more preferably according to (ii) the loading of the total amount of platinum group metals contained in the inlet coating is in the range of from greater than 1.77 g/L (50 g/ft³) to less than 2.12 g/L (60 g/ft³).

A further preferred embodiment (18) concretizing embodiment (16) or (17) relates to said system, wherein according to (ii) the inlet coating of the DOC has a Pt/Pd weight ratio in the range of from 5:1 to 1:5, preferably in the range of from 4:1 to 1:4, more preferably in the range of from 2:1 to 1:3, more preferably in the range of from 1:1 to 1:2, and more preferably in the range of from 1 : 1.4 to 1 : 1.8.

A further preferred embodiment (19) concretizing any one of embodiments (16) to (18) relates to said system, wherein according to (ii) the loading of the total amount of platinum group metals, calculated as elemental platinum group metal, contained in the outlet coating of the DOC is in the range of from 0.04 to 2.47 g/L (1 to 70 g/ft³), preferably in the range of from 0.04 to 1.77 g/L (1 to 50 g/ft³), more preferably in the range of from 0.04 to 1.05 g/L (1 to 30 g/ft³), more preferably in the range of from 0.04 to 0.71 g/L (1 to 20 g/ft³), more preferably in the range of from 0.07 to 0.53 g/L (2 to 15 g/ft³), more preferably in the range of from 0.11 to 0.28 g/L (3 to 8 g/ft³); wherein more preferably according to (ii) the loading of the total amount of platinum group metals, calculated as elemental platinum group metal, contained in the outlet coating is in the range of from greater than 0.14 g/L (4 g/ft³) to less than 0.22 g/L (6 g/ft³).

A further preferred embodiment (20) concretizing any one of embodiments (16) to (19) relates to said system, wherein according to (ii) the outlet coating of the DOC has a Pt/Pd weight ratio in the range of from 10:1 to 1:0, preferably in the range of from 5:1 to 1:1, more preferably in the range of from 4:1 to 2:1, and more preferably in the range of from 3.5:1 to 2.5:1.

A further preferred embodiment (21) concretizing any one of embodiments (16) to (20) relates to said system, wherein the according to (ii) the inlet coating length x as % of the substrate axial length of the substrate of the DOC is in the range of from 5 to 80, preferably in the range of from 10 to 70, more preferably in the range of from 15 to 60, more preferably in the range of from 20 to 60, more preferably in the range of from 25 to 55, more preferably in the range of from 30 to 50, and more preferably in the range of from 35 to 45.

A further preferred embodiment (22) concretizing any one of embodiments (16) to (21) relates to said system, wherein according to (ii), the inlet coating and/or outlet coating of the DOC do not contain platinum group metals other than Pt and/or Pd beyond contaminants less than 2% by weight of the total sum weight of Pt and Pd, preferably less than 1% by weight of the total sum weight of Pt and Pd, and more preferably less than 0.5% by weight of the total sum weight of Pt and Pd.

A further preferred embodiment (23) concretizing any one of embodiments (16) to (22) relates to said system, wherein according to (ii) the internal walls of the inlet and outlet passages of the DOC comprise an undercoat that extends from the inlet end coating length to the outlet end coating length of the substrate.

A further preferred embodiment (24) concretizing embodiment (23) relates to said system, wherein according to (ii) the undercoat of the DOC comprises, optionally consists of, one or more of pseudoboehmite, y-alumina, alumina, silica, lanthana, zirconia, titania, ceria, baria, and mixtures thereof, preferably one or more of pseudoboehmite, y-alumina, alumina, silica, lanthana, and mixtures thereof, more preferably the undercoat comprises, optionally consists of, pseudoboehmite.

A further preferred embodiment (25) concretizing any one of embodiments (16) to (24) relates to said system, wherein according to (ii) no platinum group metals are intentionally present in the undercoat of the DOC.

A further preferred embodiment (26) concretizing any one of embodiments (16) to (25) relates to said system, wherein according to (ii) the undercoat of the DOC has a DV90 value of the particle size distribution in the range of from 0.1 to 25 microns, preferably in the range of from 5 to 15 microns, more preferably in the range of from 7 to 13 microns, more preferably in the range of from 8 to 12 microns; wherein more preferably according to (ii) the undercoat has a DV90 value of the particle size distribution in the range of 9 to 11 microns, wherein preferably the particles size distribution is measured by light scattering, more preferably according to reference example 1.

A further preferred embodiment (27) concretizing any one of embodiments (16) to (26) relates to said system, wherein according to (ii) the undercoat of the DOC contains less than 0.1 wt.-% of platinum group metals calculated on the basis of the total dry mass of the undercoat, preferably less than 0.01 wt.-% of platinum group metals.

A further preferred embodiment (28) concretizing any one of embodiments (16) to (27) relates to said system, wherein according to (ii) the substrate of the DOC has an undercoat loading in the range of 15 to 92 g/L (0.25 to 1.5 g/in³), preferably in the range of 31 to 75 g/L (0.5 to 1.25 g/in³), and more preferably in the range of 55 to 67 g/L (0.9 to 1.1 g/in³).

A further preferred embodiment (29) concretizing any one of embodiments (16) to (28) relates to said system, wherein according to (ii) no layer is between the undercoat and the substrate of the DOC.

A further preferred embodiment (30) concretizing any one of embodiments (16) to (29) relates to said system, wherein according to (ii) no layer is between the undercoat and the inlet and/or outlet coating containing platinum group metals of the DOC.

A further preferred embodiment (31) concretizing any one of embodiments (1) to (30) relates to said system, wherein according to (ii) the total loading of platinum group metals, calculated as elemental platinum group metal, present in the DOC is in the range of from 0.35 g/L to 1.77 g/L (10 g/ft³ to 50 g/ft³), preferably in the range of from 0.53 g/L to 1.59 g/L (15 g/ft³ to 45 g/ft³), more preferably in the range of from 0.71 g/L to 1.41 g/L (20 g/ft³ to 40 g/ft³), more preferably in the range of from 0.74 g/L to 1.02 g/L (21 g/ft³ to 29 g/ft³); wherein more preferably according to (ii) the total loading of platinum group metals, calculated as elemental platinum group metal, present in the DOC is in the range of from greater than 0.81 g/L (23 g/ft³) to less than 0.88 g/L (25 g/ft³).

A further preferred embodiment (32) concretizing any one of embodiments (1) to (31) relates to said system, wherein according to (ii) the DOC has a total length, preferably substrate length, in the range of from 2.54 to 25.4 cm (1 to 10 inches), preferably in the range of from 3.81 to 20.32 cm (1.5 to 8 inches), more preferably in the range of from 5.08 to 17.78 cm (2 to 7 inches), more preferably in the range of from 5.08 to 15.24 cm (2 to 6 inches), more preferably in the range of from 7.62 to 12.7 cm (3 to 5 inches).

A further preferred embodiment (33) concretizing any one of embodiments (1) to (32) relates to said system, wherein according to (ii) the DOC has a total width, preferably substrate width, in the range of from 10.16 to 43.18 cm (4 to 17 inches), preferably in the range of from 17.78 to 38.10 cm (7 to 15 inches), more preferably in the range of from 20.32 to 35.56 cm (8 to 14 inches), more preferably in the range of from 22.86 to 33.02 cm (9 to 13 inches), more preferably in the range of from 22.86 to 27.94 cm (9 to 11 inches).

A further preferred embodiment (34) concretizing any one of embodiments (2) to (33) relates to said system, wherein the zeolitic material comprised in the catalyst coating of the MFC according to (iv) has a framework structure of the type AEI, GME, CHA, MFI, BEA, FAU, MOR or mixtures of two or more thereof, preferably a framework structure of the type AEI, CHA, BEA or mixtures of two or more thereof, more preferably a framework structure of the type CHA or AEI, more preferably a framework structure of the type CHA.

A further preferred embodiment (35) concretizing embodiment (34) relates to said system, wherein the zeolitic material comprised in the catalyst coating of the MFC according to (iv) comprises copper, wherein the amount of copper comprised in the zeolitic material, calculated as CuO, is preferably in the range of from 0.1 to 10.0 weight-%, more preferably in the range of from 2.0 to 7.0 weight-%, more preferably in the range of from 2.5 to 5.5 weight-%, more preferably in the range of from 2.5 to 3.5 weight-%, based on the total weight of the zeolitic material; wherein the amount of iron comprised in the zeolitic material, calculated as Fe₂O₃, is preferably in the range of from 0 to 0.01 weight-%, more preferably in the range of from 0 to 0.001 weight-%, more preferably in the range of from 0 to 0.0001 weight-%, based on the total weight of the zeolitic material.

A further preferred embodiment (36) concretizing embodiment (34) or (35) relates to said system, wherein from 95 to 100 weight-%, preferably from 98 to 100 weight-%, more preferably from 99 to 100 weight-% of the framework structure of the zeolitic material consist to Si, Al, O, and optionally one or more of H and P, wherein in the framework structure, the molar ratio of Si to Al, calculated as molar SiO₂ — Al₂O₃, is preferably in the range of from 2:1 to 50:1, more preferably in the range of from 4:1 to 45:1, more preferably in the range of from 10:1 to 40: 1, more preferably in the range of from 15: 1 to 30: 1.

A further preferred embodiment (37) concretizing embodiment (34) relates to said system, wherein the zeolitic material comprised in the catalyst coating of the MFC according to (iv) comprises iron, wherein the amount of iron comprised in the zeolitic material, calculated as Fe₂O₃, is preferably in the range of from 0.1 to 10.0 weight-%, more preferably in the range of from 1.0 to 7.0 weight-%, more preferably in the range of from 2.5 to 5.5 weight-% based on the total weight of the zeolitic material, and wherein preferably from 95 to 100 weight-%, more preferably from 98 to 100 weight-%, more preferably from 99 to 100 weight-% of the framework structure of the zeolitic material consist to Si, Al, O, and optionally one or more of H and P, wherein in the framework structure, the molar ratio of Si to Al, calculated as molar SiO₂ — Al₂O₃, is preferably in the range of from 2:1 to 50:1, more preferably in the range of from 4:1 to 45:1, more preferably in the range of from 10:1 to 40: 1, more preferably in the range of from 15: 1 to 30: 1.

A further preferred embodiment (38) concretizing any one of embodiments (1) to (37) relates to said system, wherein the zeolitic material comprised in the catalyst coating of the MFC according to (iv), preferably which has a framework type CHA, has a mean crystallite size of at least 0.5 micrometer, preferably in the range of from 0.5 to 1.5 micrometers, more preferably in the range of from 0.6 to 1.0 micrometer, more preferably in the range of from 0.6 to 0.8 micrometer determined via scanning electron microscopy.

A further preferred embodiment (39) concretizing any one of embodiments (1) to (38) relates to said system, wherein the catalyst coating of the MFC according to (iv) further comprises a metal oxide binder, wherein the metal oxide binder preferably comprises one or more of zirconia, alumina, titania, silica, and a mixed oxide comprising two or more of Zr, Al, Ti, and Si, more preferably comprises one or more of alumina and zirconia, more preferably comprises zirconia; wherein the coating comprises the metal oxide binder with a loading in the range of from 1.22 to 12 g/L (0.02 to 0.2 g/in³), preferably in the range of from 4.88 to 72 g/L (0.08 to 0.18 g/in³).

A further preferred embodiment (40) concretizing any one of embodiments (1) to (39) relates to said system, wherein in (iv) the one or more platinum group metals are supported on a refractory metal oxide, wherein the refractory metal oxide comprised in the catalyst coating of the MFC according to (iv) comprises one or more of zirconia, silica, alumina and titania, preferably one or more of zirconia and alumina.

A further preferred embodiment (41) concretizing embodiment (40) relates to said system, wherein the one or more platinum group metals are supported on zirconia.

A further preferred embodiment (42) concretizing embodiment (41) relates to said system, wherein from 90 to 100 weight-%, preferably from 95 to 100 weight-%, more preferably from 99 to 100 weight-% of the refractory metal oxide comprised in the catalyst coating of the MFC according to (iv) consist of zirconia.

A further preferred embodiment (43) concretizing any one of embodiments (1) to (42) relates to said system, wherein the catalyst coating of the MFC according to (iv) comprises the zeolitic material with a loading in the range of from 61 to 275 g/L (1.0 to 4.5 g/in³), preferably in the range of from 92 to 244 g/L (1.5 to 4.0 g/in³), more preferably in the range of from 122 to 214 g/L (2.0 to 3.5 g/in³), more preferably in the range of from 128 to 183 g/L (2.1 to 3 g/in³), more preferably in the range of from 128 to 159 g/L (2.1 to 2.6 g/in³).

A further preferred embodiment (44) concretizing any one of embodiments (1) to (43) relates to said system, wherein the catalyst coating of the MFC according to (iv) comprises the one or more platinum group metals at a loading, calculated as elemental platinum group metal, in the range of from 0.04 to 2.83 g/L (1 to 80 g/ft³), preferably in the range of from 0.53 to 2.12 g/L (15 to 60 g/ft³), more preferably in the range of from 0.71 to 1.77 g/L (20 to 50 g/ft³), more preferably in the range of from 0.88 to 1.59 g/L (25 to 45 g/ft³), more preferably in the range of from 0.88 to 1.24 g/L (25 to 35 g/ft³).

A further preferred embodiment (45) concretizing any one of embodiments (1) to (44) relates to said system, wherein from 95 to 100 weight-%, preferably from 98 to 100 weight-%, more preferably from 99 to 100 weight-%, more preferably from 99.5 to 100 weight-% of the catalyst coating of the MFC according to (iv) comprise, preferably consist of, the one or more platinum group metals supported on a refractory metal oxide, wherein from 99 to 100 weight-% of said refractory metal oxide consist of zirconium and oxygen, preferably of zirconia, a copper containing zeolitic material having a framework structure of the type CHA, and preferably a metal oxide binder as defined in embodiment 41.

A further preferred embodiment (46) concretizing any one of embodiments (1) to (45) relates to said system, wherein from 0 to 0.0035 g/l, preferably from 0 to 0.00035 g/l, more preferably from 0 to 0.000035 g/l, more preferably from 0 to 0.0000035 g/l of one or more of platinum, iridium, osmium and rhodium are comprised in the coating of the MFC according to (iv), wherein more preferably from 0 to 0.0000035 g/l of platinum, iridium, osmium and rhodium are comprised in the coating of the MFC according to (iv).

A further preferred embodiment (47) concretizing any one of embodiments (1) to (46) relates to said system, wherein the catalyst coating of the MFC according to (iv) is free of platinum, preferably free of platinum and rhodium, more preferably free of platinum, iridium, osmium and rhodium.

A further preferred embodiment (48) concretizing any one of embodiments (40) to (42) and (45) relates to said system, wherein from 0 to 2 weight-%, preferably from 0 to 1 weight-%, more preferably from 0 to 0.1 weight-% of the refractory metal oxide supporting the one or more platinum group metals comprised in the catalyst coating of the MFC according to (iv) consist of ceria and alumina, wherein more preferably from 0 to 0.1 weight-% of the refractory metal oxide comprised in the catalyst coating of the MFC according to (iv) consists of ceria, alumina, titania, lanthana and baria.

A further preferred embodiment (49) concretizing any one of embodiments (40) to (42) and (45) relates to said system, wherein the refractory metal oxide supporting the one or more platinum group metals comprised in the catalyst coating of the MFC according to (iv) is free of ceria and alumina, preferably free of ceria, alumina and titania, more preferably free of ceria, alumina, titania, lanthana and baria.

A further preferred embodiment (50) concretizing any one of embodiments (1) to (49) relates to said system, wherein the catalyst coating of the MFC according to (iv) comprises a copper containing zeolitic material having a framework structure of the type CHA and palladium supported on zirconia comprised as a single coat, wherein the single coat is disposed on at least a portion of the internal walls of the substrate of the MFC according to (iv).

A further preferred embodiment (51) concretizing any one of embodiments (1) to (49) relates to said system, wherein the catalyst coating of the MFC according to (iv) comprises a copper containing zeolitic material having a framework structure of the type CHA and the one or more platinum group metals are supported on a refractory metal oxide comprising one or more of zirconia, alumina and titania, preferably one or more of alumina and zirconia, and the catalyst coating consists of an overcoat, wherein the copper containing zeolitic material having a framework structure of the type CHA is comprised, and an undercoat, wherein the platinum group metal supported on an refractory metal oxide is comprised, wherein the undercoat is disposed on at least a portion of the surface of the internal walls of the substrate of the MFC according to (iv) and the overcoat is disposed on the undercoat.

A further preferred embodiment (52) concretizing embodiment (51) relates to said system, wherein the platinum group metal comprised in the undercoat of the MFC according to (iv) is palladium.

A further preferred embodiment (53) concretizing embodiment (51) or (52) relates to said system, wherein the refractory metal oxide comprised in the undercoat of the MFC according to (iv) comprises, preferably consists of, one or more of alumina and zirconia.

A further preferred embodiment (54) concretizing any one of embodiments (51) to (53) relates to said system, wherein from 60 to 100 weight-%, preferably from 70 to 90 weight-%, more preferably from 75 to 85 weight-% of the refractory metal oxide comprised in the undercoat of the MFC according to (iv) consist of alumina.

A further preferred embodiment (55) concretizing any one of embodiments (52) to (55) relates to said system, wherein the undercoat of the MFC according to (iv) comprises palladium at a loading, calculated as elemental palladium, in the range of from 0.04 to 1.77 g/L (1 to 50 g/ft³), preferably in the range of from 0.18 to 1.06 g/L (5 to 30 g/ft³), more preferably in the range of from 0.35 to 0.88 g/L (10 to 25 g/ft³), more preferably in the range of from 0.42 to 0.64 g/L (12 to 18 g/ft³).

A further preferred embodiment (56) concretizing any one of embodiments (51) to (55) relates to said system, wherein from 95 to 100 weight-%, preferably from 98 to 100 weight-%, more preferably from 99 to 100 weight-%, more preferably from 99.5 to 100 weight-% of the undercoat of the MFC according to (iv) comprises, preferably consist of, palladium supported on a refractory metal oxide, wherein from 99.5 to 100 weight-% of said refractory metal oxide comprises, more preferably consists of, one or more of alumina and zirconia.

A further preferred embodiment (57) concretizing any one of embodiments (51) to (56) relates to said system, wherein the overcoat of the MFC according to (iv) comprises the zeolitic material at a loading in the range of from 61 to 275 g/L (1 to 4.5 g/in³), preferably in the range of from 92 to 244 g/L (1.5 to 4 g/in³), more preferably in the range of from 122 to 244 g/L (2 to 4 g/in³), more preferably in the range of from 153 to 214 g/L (2.5 to 3.5 g/in³).

A further preferred embodiment (58) concretizing any one of embodiments (51) to (57) relates to said system, wherein from 95 to 100 weight-%, preferably from 98 to 100 weight-%, more preferably from 99 to 100 weight-%, more preferably from 99.5 to 100 weight-% of the undercoat of the MFC according to (iv) comprises, preferably consists of, palladium supported on a refractory metal oxide, wherein from 99.5 to 100 weight-% of said refractory metal oxide comprises, more preferably consists of, one or more of alumina and zirconia; and wherein from 95 to 100 weight-%, preferably from 98 to 100 weight-%, more preferably from 99 to 100 weight-%, more preferably from 99.5 to 100 weight-% of the overcoat of the MFC according to (iv) comprises, preferably consists of, a copper containing zeolitic material having a framework structure of the type CHA, and preferably a metal oxide binder as defined in embodiment 41.

A further preferred embodiment (59) concretizing any one of embodiments (51) to (58) relates to said system, wherein from 0 to 0.0035 g/l, preferably from 0 to 0.00035 g/l, more preferably from 0 to 0.000035 g/l of one or more of platinum, iridium, osmium and rhodium are comprised in the undercoat of the MFC according to (iv), wherein more preferably from 0 to 0.000035 g/l of platinum, iridium, osmium and rhodium are comprised in the undercoat of the MFC according to (iv).

A further preferred embodiment (60) concretizing any one of embodiments (51) to (59) relates to said system, wherein the undercoat of the MFC according to (iv) is free of platinum and rhodium, preferably free of platinum, rhodium, iridium and osmium.

A further preferred embodiment (61) concretizing any one of embodiments (1) to (60) relates to said system, wherein the MFC according to (iv) consists of a coating disposed on a substrate.

A further preferred embodiment (62) concretizing any one of embodiments (1) to (61) relates to said system, wherein the substrate of the MFC according to (iv) comprises a ceramic or metallic substance.

A further preferred embodiment (63) concretizing any one of embodiments (1) to (62) relates to said system, wherein the substrate of the MFC according to (iv) comprises, preferably consists of, a ceramic substance, wherein the ceramic substance preferably comprises, more preferably consists of, one or more of an alumina, a silica, a silicate, an aluminosilicate, preferably a cordierite or a mullite, an aluminotitanate, a silicon carbide, a zirconia, a magnesia, preferably a spinel, and a titania, more preferably one or more of a silicon carbide and a cordierite, more preferably a cordierite; or wherein the substrate of the MFC according to (iv) comprises, preferably consists of, a metallic substance, wherein the metallic substance preferably comprises, more preferably consists of, oxygen and one or more of iron, chromium and aluminum.

A further preferred embodiment (64) concretizing any one of embodiments (1) to (63) relates to said system, wherein the substrate of the MFC according to (iv) is a monolith, preferably a honeycomb monolith, more preferably a flow-through honeycomb monolith.

A further preferred embodiment (65) concretizing any one of embodiments (1) to (64) relates to said system, wherein the MFC according to (iv) has a length, preferably a substrate length, in the range of from 2.54 to 25.4 cm (1 to 10 inches), preferably in the range of from 3.81 to 20.32 cm (1.5 to 8 inches), more preferably in the range of from 5.08 to 17.78 cm (2 to 7 inches), more preferably in the range of from 5.08 to 15.24 cm (2 to 6 inches), more preferably in the range of from 5.08 to 10.16 cm (2 to 4 inches).

A further preferred embodiment (66) concretizing any one of embodiments (1) to (65) relates to said system, wherein the MFC according to (iv) has a width, preferably a substrate width, in the range of from 10.16 to 43.18 cm (4 to 17 inches), preferably in the range of from 17.78 to 38.10 cm (7 to 15 inches), more preferably in the range of from 20.32 to 35.56 cm (8 to 14 inches), more preferably in the range of from 22.86 to 33.02 cm (9 to 13 inches), more preferably in the range of from 22.86 to 27.94 cm (9 to 11 inches).

A further preferred embodiment (67) concretizing any one of embodiments (1) to (66) relates to said system, wherein the catalyst coating of the MFC according to (iv) is disposed on the internal walls of the substrate of the MFC according to (iv) over 20 to 100 %, preferably over 50 to 100 %, more preferably over 75 to 100 %, more preferably over 95 to 100 %, more preferably over 99 to 100 % of the substrate length.

According to an embodiment (68), the present invention relates to a method for the simultaneous selective catalytic reduction of NOx, the oxidation of hydrocarbon, the oxidation of nitrogen monoxide and the oxidation of ammonia, comprising
(1) providing an exhaust gas stream from a diesel engine comprising one or more of NOx, ammonia, nitrogen monoxide and a hydrocarbon;
(2) passing the exhaust gas stream provided in (1) through the exhaust gas system according to any one of embodiments 1 to 67.

According to an embodiment (69), the present invention relates to a method for preparing an exhaust gas treatment system according to any one of embodiments 1 to 67 comprising preparing a diesel oxidation catalyst (DOC) according to a process comprising
(a) preparing a first slurry comprising a platinum group metal, a refractory metal oxide support, and water,
(b) providing a substrate,
(c) disposing the first slurry obtained in (a) on the substrate according to (b), coating the internal walls of the inlet passages such that the inlet coating extends from the inlet end to an inlet coating end whereby an inlet coating length is defined, wherein the inlet coating length is x % of the substrate axial length with 0 < x < 100, obtaining a slurry-treated substrate;
(d) drying the slurry-treated substrate obtained in (c), obtaining a substrate having an inlet coating disposed thereon;
(e) calcining the slurry-treated substrate obtained in (c), obtaining an inlet coated substrate,
(f) preparing a second slurry comprising a platinum group metal, a refractory metal oxide support, and water,
(g) disposing the second slurry obtained according to (f) on the substrate obtained according to (e), coating the internal walls of the outlet passages such that the outlet coating extends from the outlet end to an outlet coating end whereby an outlet coating length is defined, wherein the outlet coating length is (100-x)% of the substrate axial length, obtaining an inlet coated and outlet slurry treated substrate,
(h) drying the slurry-treated substrate obtained in (g), obtaining a substrate having inlet and outlet coatings disposed thereon,
(j) calcining the slurry-treated substrate obtained in (g), for obtaining a DOC, preferably a DOC according to (ii) comprised in the exhaust gas treatment system according to any one of embodiments 1 to 67.

A preferred embodiment (70) concretizing embodiment (69) relates to said method, wherein step (a) and/or step (f) further comprises the steps of
(1.1) providing a refractory metal oxide support comprising, preferably consisting of, pseudoboehmite, alumina, γ-alumina, silica stabilized titania, lanthana, lanthana stabilized alumina, silica stabilized alumina, zirconia, titania, ceria, ceria-zirconia, aluminosilicate, silica, rare-earth metal sesquioxide, and mixtures thereof, preferably pseudoboehmite, alumina, γ-alumina, titania, silica stabilized titania, silica stabilized alumina, and mixtures thereof, preferably pseudoboehmite and/or silica stabilized alumina, preferably an equal weight mixture of pseudoboehmite and 2 to 6 wt.-% silica stabilized alumina; preferably wherein the refractory metal oxide support is acidic, preferably having a pH in the range of 2 to less than 7, wherein preferably the pH is adjusted by addition of an inorganic acid nitric acid and/or an organic acid consisting of one or more acetic, propionic, oxalic, malonic, succinic, glutamic, adipic, maleic, fumaric, phthalic, tartaric, and citric acid, preferably acetic acid;
(1.2) adding a platinum group metal by means of incipient wetness, wherein preferably the platinum group metal comprises, preferably consists of, platinum, preferably palladium and platinum, obtaining a platinum group metal supported on a refractory metal oxide, preferably a first platinum group metal supported on a refractory metal oxide;
(1.3) optionally repeating steps (1.1) and (1.2) with the same refractory metal oxide support according to (1.1) and a different platinum group metal according to (1.2), obtaining a second platinum group metal supported on a refractory metal oxide and mixing the first and second platinum group metals supported on a refractory metal oxide, obtaining a mechanical mixture of first and second platinum group metals supported on a refractory metal oxide;
(1.4) optionally adding barium salt and/or a lanthanum salt to the platinum group metal supported on a refractory metal oxide obtained from (1.2) or the mechanical mixture of first and second platinum group metals supported on a refractory metal oxide from (1.3), obtaining a platinum group metal supported on a refractory metal oxide containing barium and/or lanthanum or a mechanical mixture of first and second platinum group metals supported on a refractory metal oxide containing barium and/or lanthanum,
(1.5) optionally adding a binder to the platinum group metal supported on a refractory metal oxide obtained from (1.2) or (1.4) or the mechanical mixture of first and second platinum group metals supported on a refractory metal oxide from (1.3) or (1.4), wherein preferably the binder comprises, preferably consists of, one or more of zirconia, titania, alumina, silica, and mixtures thereof, preferably zirconia, alumina and mixtures thereof, preferably zirconia;
(1.6) optionally milling the platinum group metal supported on a refractory metal oxide obtained from (1.2), (1.4) or (1.5) or the mechanically mixed platinum group metals supported on a refractory metal oxide obtained from (1.3), (1.4) or (1.5), obtaining a platinum group metal supported on a refractory metal oxide or mechanical mixture of platinum group metals supported on a refractory metal oxide having a DV90 value of the particle size distribution in the range of 0.1 to 25 microns, preferably in the range of 1 to 20 microns, more preferably in the range of 2 to 18 microns, more preferably in the range of 3 to 17 microns, more preferably in the range of 4 to 16 microns, more preferably in the range of 5 to 15 microns, and more preferably in the range of 7 to 12 microns; wherein more preferably the DV90 value of the particle size distribution of the refractory metal oxide support or the mechanically mixed platinum group metals supported on a refractory metal oxide is in the range of 10 to 12 microns, wherein preferably the particles size distribution is measured by light scattering, more preferably according to reference example 1;
(1.7) dispersing the platinum group metal supported on a refractory metal oxide obtained from (1.2), (1.4), (1.5) or (1.6) or the mechanical mixture of platinum group metals supported on a refractory metal oxide obtained from (1.3), (1.4), (1.5) or (1.6) in water, thereby obtaining a first slurry according to step (a) and/or second slurry according to step (f).

A further preferred embodiment (71) concretizing embodiment (69) or (70) relates to said method, wherein step (a) and/or step (f) further comprise adding a binder, preferably in the range of from 2 to 7 wt.-% calculated on the basis of the total dry weight components present in the individual layer, preferably in the range of 3 to 6 wt.-%, wherein preferably the binder comprises, preferably consists of, one or more of zirconia, titania, alumina, silica, and mixtures thereof, preferably zirconia, alumina and mixtures thereof, preferably zirconia.

A further preferred embodiment (72) concretizing anyone of embodiments (69) to (71) relates to said method, wherein the substrate according to (b) comprises, preferably consists of, a ceramic substance, wherein the ceramic substance preferably comprises, more preferably consists of, one or more of an alumina, a silica, a silicate, an aluminosilicate, preferably a cordierite or a mullite, an aluminotitanate, a silicon carbide, a zirconia, a magnesia, preferably a spinel, and a titania, more preferably one or more of a silicon carbide and a cordierite, more preferably a cordierite.

A further preferred embodiment (73) concretizing anyone of embodiments (69) to (71) relates to said method, wherein the substrate according to (b) comprises, preferably consists of, a metallic substance, wherein the metallic substance preferably comprises, more preferably consists of, oxygen and one or more of iron, chromium and aluminum.

A further preferred embodiment (74) concretizing anyone of embodiments (69) to (73) relates to said method, wherein according to (ii) the substrate of the DOC is a monolith, preferably a honeycomb monolith, more preferably a flow-through honeycomb monolith.

A further preferred embodiment (75) concretizing anyone of embodiments (69) to (74) relates to said method, wherein the substrate provided in step (b) has an undercoat, preferably obtained by the steps comprising
(b.1) providing a refractory metal oxide support comprising, optionally consisting of, one or more of pseudoboehmite, γ-alumina, alumina, silica, lanthana, zirconia, titania, ceria, baria, and mixtures thereof, preferably one or more of pseudoboehmite, γ-alumina, alumina, silica, lanthana, and mixtures thereof, more preferably the undercoat comprises, optionally consists of, pseudoboehmite;
(b.2) optionally milling the refractory metal oxide support provided in (b.1), preferably obtaining a refractory metal oxide support having a DV90 value of the particle size distribution in the range of from 0.1 to 25 microns, preferably in the range of from 5 to 15 microns, more preferably in the range of from 7 to 13 microns, more preferably in the range of from 8 to 12 microns; wherein more preferably obtaining a refractory metal oxide support having a DV90 value of the particle size distribution in the range of 9 to 11 microns, wherein preferably the particles size distribution is measured by light scattering, more preferably according to reference example 1;
(b.3) coating the entire length of the inlet and outlet of the substrate with the refractory metal oxide support obtained according to (b.1) or (b.2), obtaining an undercoated substrate;
(b.4) optionally drying and/or calcining the undercoated substrate according to (b.3), obtaining a dried and/or calcined undercoated substrate.

A further preferred embodiment (76) concretizing anyone of embodiments (69) to (75) relates to said method, wherein the substrate provided in (b) has an undercoat loading in the range of 15 to 92 g/L (0.25 to 1.5 g/in³), preferably in the range of 31 to 76 g/L (0.5 to 1.25 g/in³), and more preferably in the range of 55 to 67 g/L (0.9 to 1.1 g/in³).

A further preferred embodiment (77) concretizing embodiment (75) or (76) relates to said method, wherein according to step (b) no platinum group metals are intentionally present in the undercoat of the DOC.

A further preferred embodiment (78) concretizing anyone of embodiments (75) to (77) relates to said method, wherein according to step (b) the undercoat of the DOC contains less than 0.1 wt.% of platinum group metals calculated on the basis of the total dry mass of the undercoat, preferably less than 0.01 wt.-% of platinum group metals.

A further preferred embodiment (79) concretizing anyone of embodiments (75) to (78) relates to said method, wherein according to step (b) no layer is between the undercoat and the substrate of the DOC.

A further preferred embodiment (80) concretizing anyone of embodiments (75) to (79) relates to said method, wherein in step (c)the internal walls of the inlet passages are coated such that the inlet coating extends from the inlet end to an inlet coating end whereby an inlet coating length is defined, wherein the inlet coating length is x as % of the substrate axial length of the substrate of the DOC, and is in the range of from 5 to 80, preferably in the range of from 10 to 70, more preferably in the range of from 15 to 60, more preferably in the range of from 20 to 60, more preferably in the range of from 25 to 55, more preferably in the range of from 30 to 50, and more preferably in the range of from 35 to 45.

According to an embodiment (81), the present invention relates to a method for preparing an exhaust gas treatment system according to any one of embodiments 1 to 67 comprising preparing a multifunctional catalyst (MFC) according to a process comprising
(a′) preparing a slurry comprising palladium, an oxidic material comprising one or more of zirconium and aluminum, and water,
(b′) disposing the slurry obtained in (a) on a substrate, obtaining a slurry-treated substrate;
(c′) optionally, drying the slurry-treated substrate obtained in (b′), obtaining a substrate having a coating disposed thereon;
(d′) calcining the slurry-treated substrate obtained in (b′), preferably the dried slurry-treated substrate obtained in (c′), for obtaining an MFC catalyst, preferably an MFC according to (iv) comprised in the exhaust gas treatment system according to any one of embodiments 1 to 67.

A preferred embodiment (82) concretizing embodiment (81) relates to said method, wherein (a′) comprises
(a′.1) mixing an aqueous solution of a palladium precursor, preferably an aqueous palladium nitrate solution, with an oxidic material comprising one or more of zirconium and aluminum, obtaining palladium supported on the oxidic material;
(a′.2) calcining the palladium supported on the oxidic material obtained in (a′.1);
(a′.3) mixing the calcined palladium supported on the oxidic material obtained in (a′.2) with a disposing adjuvant, preferably one or more of tartaric acid and monoethanolamine, more preferably tartaric acid and monoethanolamine.

A further preferred embodiment (83) concretizing embodiment (82) relates to said method, wherein (a′) further comprises

(a′.4) milling the mixture obtained in (a′.3) to a particle size Dv90, as determined according to Reference Example 1, in the range of from 1 to 20 micrometers, preferably in the range of from 5 to 15 micrometers, more preferably in the range of from 9 to 11 micrometers.

A further preferred embodiment (84) concretizing embodiment (82) or (83) relates to said method, wherein, according to (a′.1), the aqueous solution of a palladium precursor, preferably an aqueous palladium nitrate solution, is added dropwise to the oxidic material.

A further preferred embodiment (85) concretizing anyone of embodiments (82) to (84) relates to said method, wherein, according to (a′.2), the palladium supported on the oxidic material is calcined in gas atmosphere having a temperature in the range of from 490 to 690° C., preferably in the range of from 540 to 640° C., more preferably in the range of from 570 to 610° C.

A further preferred embodiment (86) concretizing anyone of embodiments (82) to (85) relates to said method, wherein, according to (a′.2), the palladium supported on the oxidic material is calcined in gas atmosphere for a duration in the range of from 2 to 6 hours, preferably in the range of from 3 to 5 hours.

A further preferred embodiment (87) concretizing anyone of embodiments (81) to (86) relates to said method, wherein disposing the slurry on a substrate in (b′), wherein the substrate has a substrate length, comprises disposing the slurry on 20 to 100 %, preferably on 50 to 100 %, more preferably from on 75 to 100 %, more preferably on 95 to 100 %, more preferably on 99 to 100 % of the substrate length.

A further preferred embodiment (88) concretizing anyone of embodiments (81) to (87) relates to said method, wherein, according to (c′), the slurry-treated substrate is dried in gas atmosphere having a temperature in the range of from 90 to 200° C., preferably in the range of from 110 to 180° C., more preferably in the range of from 120 to 160° C., wherein more preferably the slurry-treated substrate is dried in gas atmosphere for a duration in the range of from 5 to 300 minutes, more preferably in the range of 10 to 120 minutes, more preferably in the range of from 20 to 60 minutes.

A further preferred embodiment (89) concretizing anyone of embodiments (81) to (88) relates to said method, wherein, according to (c′), the slurry-treated substrate is dried in gas atmosphere having a temperature in the range of from 90 to 200° C., preferably in the range of from 100 to 150° C., more preferably in the range of from 110 to 130° C., for a duration preferably in the range of from 5 to 300 minutes, more preferably in the range of from 5 to 60 minutes, more preferably in the range of from 7 to 20 minutes; and further dried in gas atmosphere having a temperature in the range of from 90 to 200° C., preferably in the range of from 140 to 180° C., more preferably in the range of from 150 to 170° C., for a duration preferably in the range of from 5 to 300 minutes, more preferably 10 to 80 minutes, more preferably in the range of from 20 to 40 minutes.

A further preferred embodiment (90) concretizing anyone of embodiments (81) to (89) relates to said method, wherein, according to (d′), the slurry-treated substrate obtained in (b′), preferably the dried slurry-treated substrate obtained in (c′), is calcined in gas atmosphere having a temperature in the range of from 300 to 600° C., preferably in the range of from 400 to 500° C., more preferably in the range of from 425 to 475° C.

A further preferred embodiment (91) concretizing anyone of embodiments (81) to (90) relates to said method, wherein, according to (d′), the slurry-treated substrate obtained in (b′), preferably the dried slurry-treated substrate obtained in (c′), is calcined in gas atmosphere for a duration in the range of from 5 to 120 minutes, preferably in the range of from 10 to 90 minutes, more preferably in the range of from 15 to 50 minutes, more preferably in the range of from 20 to 40 minutes.

A further preferred embodiment (92) concretizing anyone of embodiments (81) to (91) relates to said method, consisting of
(a′) preparing a slurry comprising palladium, an oxidic material comprising one or more of zirconium and aluminum, and water,
(b′) disposing the slurry obtained in (a′) on a substrate, obtaining a slurry-treated substrate;
(c′) drying the slurry-treated substrate obtained in (b′), obtaining a substrate having a coating disposed thereon;
(d′) calcining the dried slurry-treated substrate obtained in (c′), obtaining an MFC catalyst, preferably an MFC according to (iv) comprised in the exhaust gas treatment system according to any one of embodiments 1 to 67.

According to an embodiment (93), the present invention relates to a method for preparing an exhaust gas treatment system according to any one of embodiments 1 to 67 comprising preparing a diesel oxidation catalyst (DOC) according to any of embodiments 69 to 80 and preparing a multifunctional catalyst (MFC) according to any of embodiments 81 to 92.

### EXPERIMENTAL SECTION

### Reference Example 1: Determination of the Dv90 Values

The particle size distributions were determined by a static light scattering method using Sympatec HELOS equipment, wherein the optical concentration of the sample was in the range of from 5 to 10 %.

### Reference Example 2: Preparation of a Zoned DOC According to the Invention

A zoned DOC was prepared based on the procedure described in example 3 of WO 2014/151677 A1. In particular 10.5x4″, 400/4 (diameter: 26.67 cm (10.5 inches) × length: 10.16 cm (4 inches) cylindrically shaped substrate with 400/(2.54)² cells per square centimeter and 0.1 millimeter (4 mil) wall thickness) honeycomb substrate was coated with an undercoat, followed by a first top washcoat extending from the inlet end for 1.5″ thus forming the inlet zone, wherein said first top washcoat displayed a total loading of Pt and Pd of 55 g/ft³ at a Pt : Pd weight ratio of 1 : 1.6. A second top washcoat extending from the outlet end for 2.5″ thus forming the outlet zone was then formed, wherein said second top washcoat displayed a total loading of Pt and Pd of 5 g/ft³ at a Pt : Pd weight ratio of 3 : 1. The zoned DOC thus displayed a total loading of Pt and Pd of 23.75 g/ft³ at a Pt : Pd weight ratio of 0.76 : 1.

### Reference Example 3: Preparation of an SCR Catalyst

A zeolitic material having the framework structure type CHA comprising Cu was prepared according to the teaching of Example 2 US 8 293 199 B2 (see column 15, lines 26 to 52). A slurry containing the Cu-CHA was then prepared and disposed over the full length of an uncoated honeycomb cordierite monolith substrate (diameter: 26.67 cm (10.5 inches) × length: 15.24 cm (6 inches) cylindrically shaped substrate with 300 cells per square centimeter and 5 mil wall thickness). Afterwards, the coated substrate was dried at 120° C. for 10 minutes and at 160° C. for 30 minutes and was then calcined at 450° C. for 30 minutes. The washcoat loading after calcination was 128.15 g/l (2.1 g/in³).

### Reference Example 4: Preparation of an MFC

To a zirconium-oxide (with a pore volume of 0.420 ml/g) is added a palladium nitrate solution. After calcination at 590° C. the final Pd/Zirconia had a Pd content of 3.5 weight-% based on the weight of ZrO₂. This material was added to water and the resulting slurry was milled until the resulting Dv90 was 10 microns, as described in Reference Example 1. To an aqueous slurry of Cu-CHA (with about 3 weight-% of Cu calculated as CuO and a molar ratio SiO₂:Al₂O₃ ratio of about 32), prepared according to Reference Example 2, was added a zirconyl-acetate solution to achieve 5 weight-% ZrO₂ after calcination. This mixture was spray-dried and milled until the resulting Dv90 was 5 microns. The milled Pd/ZrO₂ slurry was added to the Zr/Cu-CHA slurry and mixed. The final slurry was then disposed over the full length of an uncoated honeycomb flow-through cordierite monolith substrate (diameter: 26.67 cm (10.5 inches) × length: 7.62 cm (3 inches) cylindrically shaped substrate with 400/(2.54)² cells per square centimeter and 0.1 millimeter (4 mil) wall thickness). Afterwards, the substrate was dried and calcined. The loading of the coating after calcination in the catalyst was about 3.0 g/in³; comprising a loading of 0.53 g/l (15 g/ft³) Pd on 30.51 g/l (0.5 g/in³) ZrO₂, and 144.02 g/l (2.36 g/in³) Cu-CHA plus 7.32 g/l (0.12 g/in³) ZrO₂.

### Reference Example 5: Preparation of a DOC Containing Pt as the Only PGM

A first slurry is prepared by mixing 9000 g of Al₂O₃ with a diluted aqueous HNO₃ solution. A second slurry of acetic acid, water and Zr(OH)₄ (3600 g) are mixed in a separate tank. The second slurry is then added to the first slurry comprising alumina, in combination with 900 g of zirconium acetate solution (30%). The resultant third slurry is then milled to achieve a Dv90 of 10 microns measured according to reference example 1. In parallel, a fourth slurry is prepared wherein 18000 g of TiO₂ is wet impregnated with a Pt solution to achieve the desired Pt loading and acetic acid and water are added to give the final TiO₂ slurry. The third Zr/AI slurry, octanol and the TiO₂/Pt comprising fourth slurry are then added to one another and mixed to obtain the final slurry with a pH of 4.5. The resultant final slurry is then coated over the full length of a cordierite substrate (diameter: 26.67 cm (10.5 inches) × length: 7.62 cm (3 inches) cylindrically shaped substrate with 400/(2.54)² cells per square centimeter and 0.1 millimeter (4 mil) wall thickness) with a loading of 62 g/L, dried at 120° C. and then calcined at 450° C. The loading of the Pt-DOC was targeted to be 0.354 g/L (21.625 g/in³).

### Example 1: Preparation of an Exhaust Gas Treatment System Comprising a Close-Coupled Pt/Pd DOC and an MFC

An exhaust gas treatment system according to the present invention was prepared by combining the DOC of reference example 2 and the MFC of reference example 4, wherein the MFC was located downstream of the DOC.

### Example 2: Preparation of an Exhaust Gas Treatment System Comprising a Close-Coupled Pt DOC and an MFC With an Ammonia Injector Located Between the DOC and MFC

An exhaust gas treatment system according to the present invention was prepared by combining the DOC of reference example 5 and the MFC of reference example 4, wherein the MFC was located downstream of the DOC. An ammonia injector was located downstream of the DOC and upstream of the MFC with no intervening catalysts present between the DOC or MFC and the ammonia injector.

### Comparative Example 1: Preparation of an Exhaust Gas Treatment System Comprising a Close-Coupled DOC and an SCR Catalyst

An exhaust gas treatment system was prepared by combining the DOC of reference example 2 and the SCR catalyst of reference example 3, wherein the SCR catalyst was located downstream of the DOC.

### Comparative Example 2: Preparation of an Exhaust Gas Treatment System Comprising a Close-Coupled Pt DOC and an MFC with an Ammonia Injector Located Upstream From the DOC and MFC.

An exhaust gas treatment system was prepared by combining the DOC of reference example 5 and the MFC of reference example 4, wherein the MFC was located downstream of the DOC. An ammonia injector was located upstream of both the DOC and MFC with no intervening catalysts present between the DOC or MFC.

### Example 3: Hydrocarbon Slip Testing

The exhaust gas treatment systems of example 1 and comparative example 2 were tested with regard to their thermal behavior as well as with regard to hydrocarbon slip from the exhaust gas treatment system when injecting hydrocarbons into the exhaust gas upstream of the close-coupled DOC.

All catalytic systems were tested under steady state conditions at an exhaust mass flow of 500 kg/hr and a targeted DOC Inlet Temperature of 270° C. The targeted outlet temperature (MFC/Cu-SCR) during the HC injection events was 500° C. The tests were conducted in an engine test cell bench, employing a 7.2 L displacement engine.

As may be taken from the results in FIGS. 1 and 2, the injection of hydrocarbons upstream of the oxidation catalyst during the testing initially leads to its combustion on the oxidation catalyst, as a result of which little hydrocarbon slip is observed. As may be taken from FIGS. 3 and 4, during said the initial phase, the temperature of the exhaust gas heated in the oxidation catalyst which then enters into the respective downstream catalyst gradually increases. During the subsequent DOC light out phase, the temperature of the exhaust gas exiting the oxidation catalyst gradually decreases (see FIGS. 3 and 4), as a result of which a corresponding sharp increase in hydrocarbon slip from the DOC is observed (see FIGS. 1 and 2).

It is, however, apparent from FIG. 1 that the hydrocarbon slip from the inventive exhaust gas treatment system only slightly increases during the DOC light out phase (see FIG. 1), whereas in the same situation a sharp spike in the hydrocarbon slip from the exhaust gas treatment system of the comparative example is observed (see FIG. 2). At the same time, it is apparent from FIG. 3 that the temperature in the multifunctional catalyst of the exhaust gas treatment system according to the invention still continually rises during the light out phase, whereas it may be taken from FIG. 4 that the temperature increase during the light out phase in the exhaust gas treatment system according to the comparative example is only minimal compared to the inventive system.

Thus, analysis of the results displayed in FIGS. 1 and 2 indicate that 81% of the incoming total hydrocarbons are converted over the multifunctional catalyst of the inventive system during the DOC light out phase, wherein only 36% of the incoming total hydrocarbons are converted over the SCR catalyst of the exhaust gas system not according to the invention. Accordingly, it has surprisingly been found that the multifunctional catalyst of the inventive system is able to convert the hydrocarbon slip that comes out of the close-coupled DOC during the light out phase, whereas the conversion over the SCR catalyst is less than half of the MFC conversion.

### Example 4: DeNOx Catalyst Testing

Example 2 and comparative example 2 were evaluated under DeNOx testing conditions to evaluate optimal placement of the ammonia injector, the results of which are shown in FIG. 5 along with N₂O formation observed during said testing. The results are obtained under steady state conditions with 200 ppm NO at an exhaust mass flow rate of 1100 kg/h and a MFC inlet temperature of 290° C. Ammonia was injected in 1.05 molar equivalents to the supplied NO either before the DOC in comparative example 2 or after the DOC in example 2.

As may be taken from the results in FIG. 5, when the urea doser is up front of the Pt-DOC, the NH₃ (i.e. reductant) that is exposed over the DOC gets completely oxidized, resulting in no reductant being left to enter the MFC and thus 0% DeNOx but a high N₂O make due to the unselective oxidation of the NH₃. If the urea doser is moved downstream of the DOC, the DeNOx reaches 73%, while the N₂O is negligible.

DeNOx testing was also conducted for Example 1 and Comparative Example 1. The catalytic systems were tested under steady state conditions at both 330° C. and 370° C. SCR/MFC Inlet temperature, with SCRin NOx levels being 220 ppm (at 330° C.) and 712 ppm (at 370° C.), respectively. The SV was 140 k/h, while the ammonia to NOx ratio (ANR) was 1 for both tests point. The tests were conducted in an engine test cell bench, employing a 7.2 L displacement engine.

As may be taken from the results in FIG. 6, these demonstrate that despite the presence of Pd in the MFC in the inventive system of Example 1, the DeNOx performance is comparable to that of the comparative system of Comparative Example 1 comprising the SCR catalyst. More specifically, NOx reduction of 51/97% for the system of Comparative Example 1 and 44/93% for the inventive system of Example 1 were observed over the SCR and MFC system respectively at 330° C. and 370° C. Accordingly, as shown in Example 3, the inventive system having an MFC downstream of a DOC surprisingly demonstrates a substantial reduction in hydrocarbon slip compared to a system having an SCR downstream of the DOC, wherein as demonstrated in the present examples the system nevertheless displays a DeNOx performance comparable to that of the system containing an SCR.

### BRIEF DESCRIPTION OF THE FIGURES

FIG. 1 shows the results from catalyst testing conducted in example 3 on the exhaust system according to the invention (Example 1), wherein the time of the experiment in seconds is plotted along the abscissa and the total hydrocarbon slip in ppm is plotted along the ordinate, and wherein the total hydrocarbon concentration entering the MFC is indicated in black and the total hydrocarbon concentration exiting the MFC is indicated in dark gray.

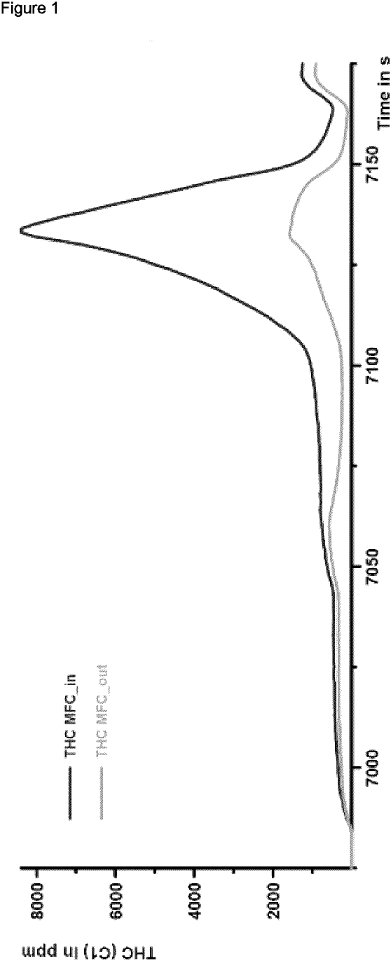

FIG. 2 shows the results from catalyst testing conducted in example 3 on the exhaust system according to the invention (Comparative example 1), wherein the time of the experiment in seconds is plotted along the abscissa and the total hydrocarbon slip in ppm is plotted along the ordinate, and wherein the total hydrocarbon concentration entering the SCR catalyst is indicated in black and the total hydrocarbon concentration exiting the SCR catalyst is indicated in dark gray.

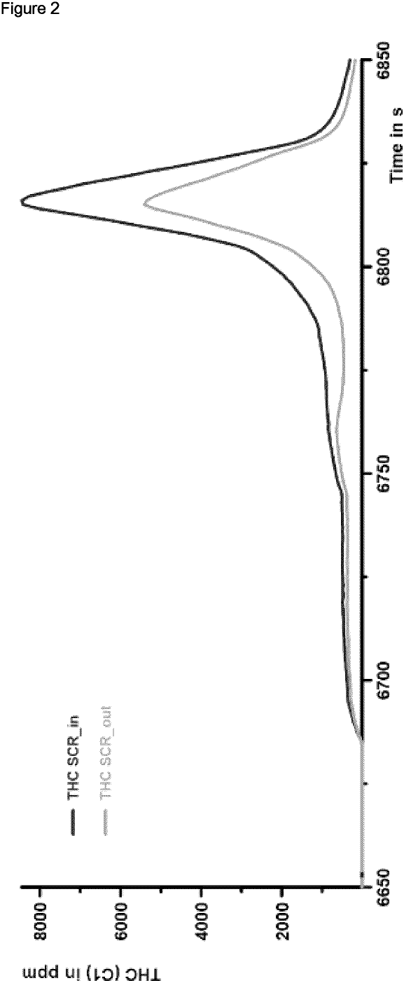

FIG. 3 shows the results from catalyst testing conducted in example 3 on the exhaust system according to the invention (Example 1), wherein the time of the experiment in seconds is plotted along the abscissa and the temperature of the exhaust gas in degrees centigrade is plotted along the ordinate, and wherein the temperature of the exhaust gas entering the MFC is indicated in black and the temperature of the exhaust gas exiting the MFC is indicated in dark gray.

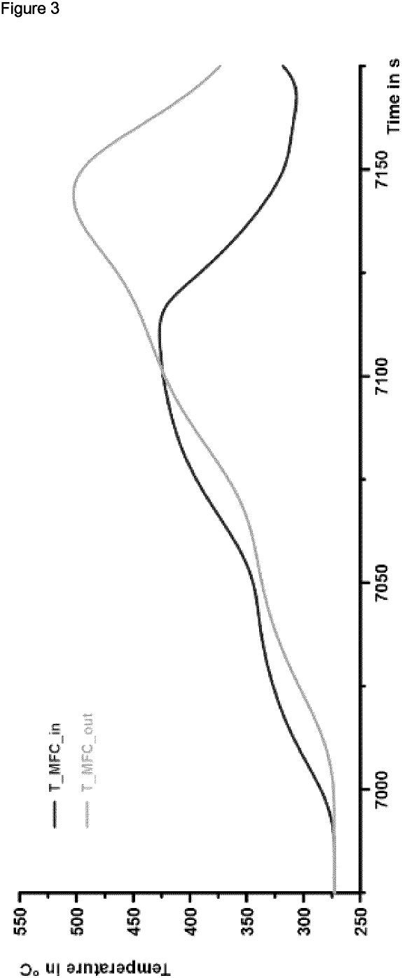

FIG. 4 shows the results from catalyst testing conducted in example 3 on the exhaust system according to the invention (Comparative example 1), wherein the time of the experiment in seconds is plotted along the abscissa and the temperature of the exhaust gas in degrees centigrade is plotted along the ordinate, and wherein the temperature of the exhaust gas entering the SCR catalyst is indicated in black and the temperature of the exhaust gas exiting the SCR catalyst is indicated in dark gray.

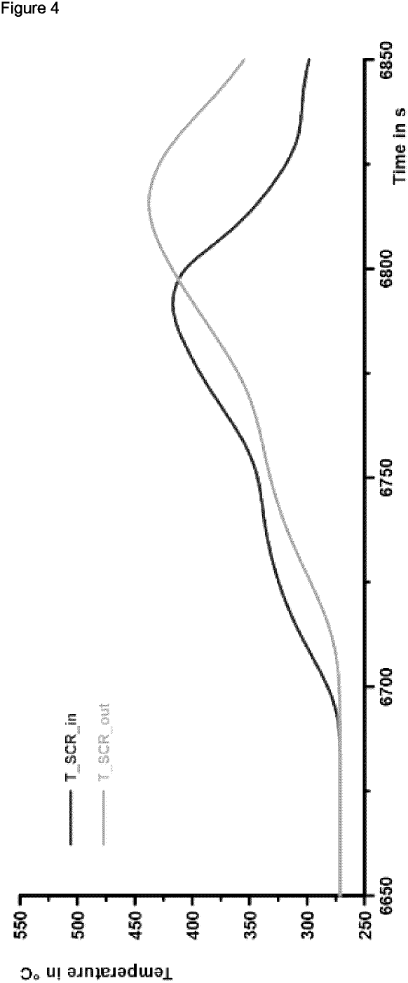

FIG. 5 shows the results from catalyst testing conducted in example 4 on the exhaust system according to the invention (Example 2) and according to a comparative example (Comparative example 2). In the histogram, the results for the inventive system are shown in solid black (NOx conversion in %) and as black stripes (N₂O production in grams), and the results for the comparative system are shown in solid grey (NOx conversion in %) and as grey stripes (N₂O production in grams).

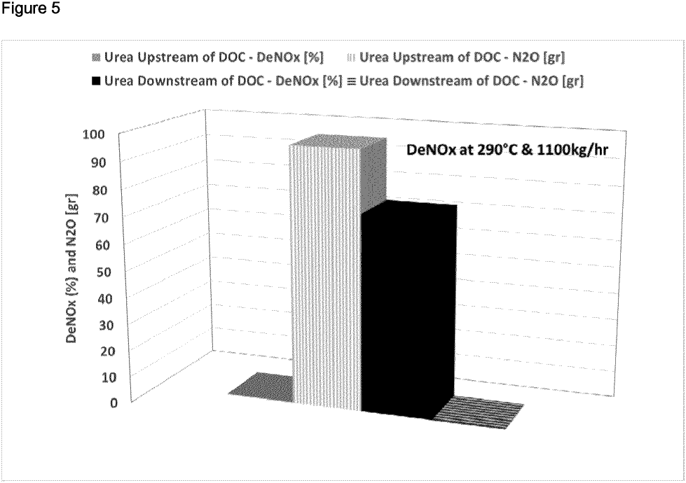

FIG. 6 shows the results from comparative testing conducted in example 4 on the exhaust system according to the invention (Example 1) and according to a comparative example (Comparative example 1). In the histogram displaying the NOx conversion in % for the inventive and comparative system at 330° C. and 370° C., respectively, the results for the inventive system are shown in grey, and the results for the comparative system are shown in black.

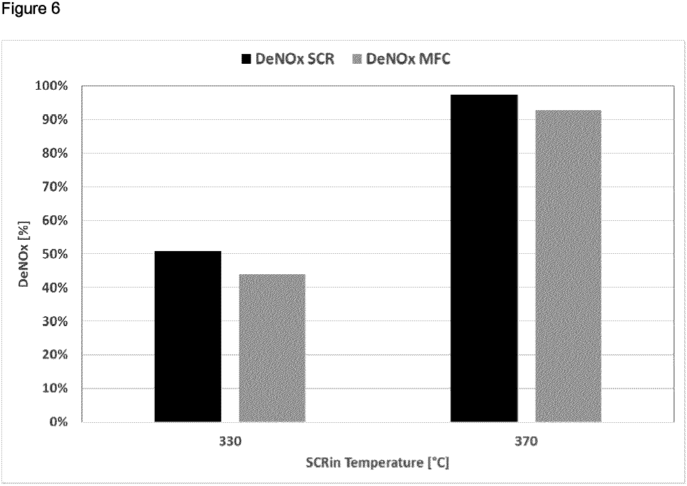

### CITED LITERATURE

WO 2018/224651 A2
WO 2019/159151 A1
WO 2014/151677 A1
US 2011/078997 A1
WO 2016/160953 A1

1-15. (canceled)

16. An exhaust gas treatment system for treating exhaust gas from a lean burn combustion engine, wherein the exhaust gas comprises hydrocarbons and NOx, the exhaust gas treatment system comprising:
(i) a means for injecting hydrocarbons into an exhaust gas stream;
(ii) a diesel oxidation catalyst (DOC) comprising a substrate and a catalyst coating provided on the substrate, wherein the catalyst coating comprises one or more platinum group metals, wherein the one or more platinum group metals comprise platinum;
(iii) a means for injecting a nitrogenous reducing agent into an exhaust gas stream; and
(iv) a multifunctional catalyst (MFC) comprising an oxidation catalyst, and a selective catalytic reduction (SCR) catalyst for the selective catalytic reduction of NOx, wherein the MFC comprises a substrate and a catalyst coating provided on the substrate, wherein the catalyst coating comprises the oxidation catalyst and the SCR catalyst, wherein the oxidation catalyst comprises one or more platinum group metals, wherein the one or more platinum group metals comprise palladium and/or platinum, and wherein the SCR catalyst comprises a zeolitic material loaded with copper and/or iron;
wherein the means for injecting hydrocarbons, the DOC, the means for injecting a nitrogenous reducing agent, and the MFC are located in sequential order in a conduit for exhaust gas, and
wherein the means for injecting hydrocarbons into the exhaust gas stream is located upstream of the DOC, wherein the DOC is located upstream of the MFC, and wherein the means for injecting the nitrogenous reducing agent into the exhaust gas stream is located between the DOC and the MFC.

17. The exhaust gas treatment system of claim 16, wherein no further component is located in the exhaust gas treatment system between the means for injecting hydrocarbons according to (i) and the DOC according to (ii).

18. The exhaust gas treatment system of claim 16, wherein the exhaust gas treatment system further comprises a lean burn engine located upstream of the DOC according to (ii).

19. The exhaust gas treatment system of claim 18, wherein the DOC according to (ii) is close-coupled to the lean burn engine.

20. The exhaust gas treatment system of claim 18, wherein the means for injecting hydrocarbons into an exhaust gas stream according to (i) is located between the lean burn engine and the DOC according to (ii).

21. The exhaust gas treatment system of claim 16, wherein according to (ii), the catalyst coating is divided into a catalytic inlet coating defining an upstream zone and a catalytic outlet coating defining a downstream zone;
wherein the substrate of the DOC has an inlet end, an outlet end, a substrate axial length extending between the inlet end and the outlet end, and a plurality of passages defined by internal walls of the substrate;
wherein the internal walls of the plurality of passages of the substrate of the DOC comprise the catalytic inlet coating extending from the inlet end to an inlet coating end and defining an inlet coating length;
wherein the inlet coating length is x % of the substrate axial length, with 0 < x < 100;
wherein the internal walls of the plurality of passages of the substrate of the DOC comprise the outlet coating extending from the outlet end to an outlet coating end and defining an outlet coating length;
wherein the outlet coating length is (100-x)% of the substrate axial length;
wherein the inlet coating length defines an upstream zone of the DOC and the outlet coating length defines a downstream zone of the DOC;
wherein the inlet coating comprises one or more platinum group metals, wherein the one or more platinum group metals comprise platinum; and
wherein the outlet coating comprises one or more platinum group metals, wherein the one or more platinum group metals comprise platinum.

22. The exhaust gas treatment system of claim 21, wherein according to (ii), the loading of the total amount of platinum group metals contained in the inlet coating of the DOC ranges from 0.18 g/L to 2.83 g/L (5 g/ft³to 80 g/ft³).

23. The exhaust gas treatment system of claim 21, wherein according to (ii), the inlet coating of the DOC has a Pt/Pd weight ratio ranging from 5:1 to 1:5.

24. The exhaust gas treatment system of claim 21, wherein according to (ii), the loading of the total amount of platinum group metals, calculated as elemental platinum group metal, contained in the outlet coating of the DOC ranges from 0.035 g/L to 2.47 g/L (1 g/ft³ to 70 g/ft³).

25. The exhaust gas treatment system of claim 21, wherein according to (ii), the outlet coating of the DOC has a Pt/Pd weight ratio ranging from 10:1 to 1:0.

26. The exhaust gas treatment system of claim 21, wherein according to (ii), the inlet coating and/or outlet coating of the DOC do not contain platinum group metals other than Pt and/or Pd beyond contaminants less than 2% by weight of the total sum weight of Pt and Pd.

27. The exhaust gas treatment system of claim 16, wherein the catalyst coating of the MFC according to (iv) comprises a copper containing zeolitic material having a framework structure of the type CHA and the one or more platinum group metals are supported on a refractory metal oxide comprising one or more of zirconia, alumina and titania, and the catalyst coating consists of an overcoat, wherein the copper containing zeolitic material having a framework structure of the type CHA is comprised, and an undercoat, wherein the platinum group metal supported on an refractory metal oxide is comprised, wherein the undercoat is disposed on at least a portion of the surface of the internal walls of the substrate of the MFC according to (iv) and the overcoat is disposed on the undercoat.

28. A method for simultaneous selective catalytic reduction of NOx, oxidation of hydrocarbons, oxidation of nitrogen monoxide, and the oxidation of ammonia, comprising:
(1) providing an exhaust gas stream from a diesel engine comprising one or more of NOx, ammonia, nitrogen monoxide and a hydrocarbon; and
(2) passing the exhaust gas stream provided in (1) through the exhaust gas system according to claim 16.

29. A method for preparing an exhaust gas treatment system according to claim 16 comprising preparing a diesel oxidation catalyst (DOC) according to a process comprising:
(a) preparing a first slurry comprising a platinum group metal, a refractory metal oxide support, and water,
(b) providing a substrate,
(c) disposing the first slurry obtained in (a) on the substrate according to (b), coating the internal walls of the inlet passages, wherein the inlet coating extends from the inlet end to an inlet coating end whereby an inlet coating length is defined, wherein the inlet coating length is x % of the substrate axial length with 0 < x < 100, obtaining a slurry-treated substrate;
(d) drying the slurry-treated substrate obtained in (c) to obtain a substrate having an inlet coating disposed thereon;
(e) calcining the slurry-treated substrate obtained in (c) to obtain an inlet coated substrate,
(f) preparing a second slurry comprising a platinum group metal, a refractory metal oxide support, and water,
(g) disposing the second slurry obtained according to (f) on the substrate obtained according to (e), coating the internal walls of the outlet passages, wherein the outlet coating extends from the outlet end to an outlet coating end whereby an outlet coating length is defined, wherein the outlet coating length is (100-x)% of the substrate axial length, obtaining an inlet coated and outlet slurry treated substrate,
(h) drying the slurry-treated substrate obtained in (g) to obtain a substrate having inlet and outlet coatings disposed thereon, and
(j) calcining the slurry-treated substrate obtained in (g), for obtaining a DOC.

30. A method for preparing an exhaust gas treatment system according to claim 16 comprising preparing a multifunctional catalyst (MFC) according to a process comprising:
(a′) preparing a slurry comprising palladium, an oxidic material comprising one or more of zirconium and aluminum, and water,
(b′) disposing the slurry obtained in (a) on a substrate to obtain a slurry-treated substrate;
(c′) optionally, drying the slurry-treated substrate obtained in (b′) to obtain a substrate having a coating disposed thereon; and
(d′) calcining the slurry-treated substrate obtained in (b′) for obtaining an MFC catalyst.
